(19) United States
(12) Patent Application Publication
(10) Pub. No.: US 2026/0290325 A1
(43) Pub. Date: Sep. 24, 2026

(54) SYSTEM

(71) Applicant: SoftBank Group Corp., Tokyo (JP)

(72) Inventor: Ruriko IKEDA, Chiyoda-ku, Tokyo (JP)

(73) Assignee: SoftBank Group Corp., Tokyo (JP)

(21) Appl. No.: 19/564,225

(22) Filed: Mar. 12, 2026

(30) Foreign Application Priority Data
Mar. 19, 2025 (JP) 2025-044894

(51) Int. Cl. G10L 15/16; G06N 3/084

(52) U.S. Cl. CPC G10L 15/16; G06N 3/084

(57) ABSTRACT

A system includes a processor that is configured to receive an operation for making a generative AI model available, analyze a user request input and create a prompt, transmit the prompt to the generative AI model and obtain a response, create a chatbot, transmit test input data and analyze a response generated by the chatbot, update learning data of the generative AI model, acquire of data of a user, identify an emotion of the user, create a prompt to generate an emotion-appropriate response, optimize the response by using the prompt, enable the user to set a custom response to a specific inquiry, create a prompt to generate a specific response, publish the chatbot, identify an interest of a chatbot user, create a prompt to generate information to provide appropriate information, identify content viewed by the user, and create a prompt to acquire information related to the identified content.

### CROSS-REFERENCE TO RELATED APPLICATION

This application is based on and claims priority under 35 USC 119 from Japanese Patent Application No. 2025-044894 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialogue systems and chatbot platforms generally rely on fixed rule-based responses or limited machine learning models, and therefore cannot flexibly utilize powerful generative AI models in a fully integrated manner from end-user devices such as smartphones, tablet terminals, and personal computers. In many cases, a user cannot easily create, test, and deploy a chatbot that leverages a generative AI model without requiring specialized technical skills. Furthermore, existing systems do not sufficiently support automatic improvement of chatbot response quality based on systematic testing and evaluation, nor do they effectively incorporate user emotions detected from multimodal inputs such as text, voice data, and camera images. In addition, typical systems do not provide a unified mechanism for: allowing users to define custom responses to specific inquiries, publishing the resulting chatbots for use by other users, analyzing operation histories of users who interact with the chatbots, and providing information tailored to identified user interests. Moreover, conventional systems lack a function for recognizing content being viewed by a user and dynamically generating or retrieving related information through a generative AI model. Accordingly, there is a need for a system that centrally manages these functions with a processor configured to control prompts to a generative AI model, thereby enabling high-quality, emotion-aware, personalized, and context-aware chatbot experiences across various devices.

### SUMMARY

In order to solve the above-described problems, a system according to one embodiment of the present invention comprises a processor configured to receive, via an application installed on an information processing device including at least one of a smartphone, a tablet terminal, and a personal computer, or via a web interface, an operation for making a generative AI model available for use, analyze a user request input from the information processing device, and create a prompt for instructing the generative AI model to generate a response. The processor is further configured to transmit the prompt to the generative AI model, obtain a response generated by the generative AI model, and create, based on the obtained response, a chatbot that provides interactive responses. In addition, the processor is configured to transmit test input data to the chatbot in order to evaluate an appropriateness of a response of the chatbot, analyze a response generated by the chatbot, and update learning data of the generative AI model using an evaluation result so as to improve a quality of responses of the chatbot. The processor is also configured to acquire at least one of input text, voice data, and camera image data of a user, analyze the acquired data to identify an emotion of the user, and create, based on the identified emotion, a prompt for instructing the generative AI model to generate an emotion-appropriate response, thereby optimizing the response. Furthermore, the processor is configured to enable the user to set a custom response to a specific inquiry based on a dialogue history and create a prompt for instructing the generative AI model to generate a specific response by using the custom response, and to publish the chatbot in an online environment or a local environment so that another user can use the chatbot. The processor is also configured to analyze an operation history of a user who uses the chatbot, identify an interest of the user, and create a prompt for instructing the generative AI model to generate information to provide appropriate information based on the identified interest, and to identify content being viewed by the user and create a prompt for instructing the generative AI model to acquire information related to the identified content. By these means, the system allows non-expert users to construct, evaluate, deploy, and continuously improve sophisticated, emotion-aware, and personalized chatbots that leverage a generative AI model across diverse usage environments.

The term “system” refers to an arrangement including at least one hardware device and associated software configured to perform the series of functions recited in the claims.

The term “processor” refers to one or more hardware processing units, such as a central processing unit (CPU), a graphics processing unit (GPU), a digital signal processor (DSP), or any combination thereof, capable of executing instructions to perform the functions described in the claims.

The term “information processing device” refers to any electronic device capable of executing an application or accessing a web interface, including but not limited to a smartphone, a tablet terminal, and a personal computer.

The term “smartphone” refers to a portable information processing device having telecommunication capability, a display, and an operating system capable of executing applications.

The term “tablet terminal” refers to a portable information processing device having a relatively large touchscreen display compared to a smartphone and an operating system capable of executing applications.

The term “personal computer” refers to a general-purpose information processing device, such as a desktop computer, a laptop computer, or a notebook computer, capable of executing various software programs.

The term “application” refers to a software program installed and executed on an information processing device to provide user interfaces and functions for operating the generative AI model and the chatbot described in the claims.

The term “web interface” refers to a user interface provided via a web browser or similar software, through which a user can access server functions over a network using web technologies such as HTTP, HTML, and JavaScript.

The term “generative AI model” refers to an artificial intelligence model, such as a large language model, a multimodal generative model, or another machine learning model, configured to generate text, audio, images, or other content in response to input data and prompts.

The term “user request” refers to an instruction or query input by a user through the application or web interface, including but not limited to natural language text, selections from a graphical user interface, and other interaction commands.

The term “prompt” refers to data generated by the processor and supplied to the generative AI model, the data including at least one of instructions, context, examples, and user inputs, and serving as a basis for the generative AI model to generate a response.

The term “response” refers to data generated by the generative AI model in reply to a prompt, including but not limited to natural language text, structured information, or other machine-generated outputs.

The term “chatbot” refers to a software entity configured to conduct an interactive dialogue with a user by using responses generated by the generative AI model and other processing described in the claims.

The term “interactive responses” refers to responses generated by the chatbot that are provided to the user in a conversational manner, where subsequent responses may depend on previous user inputs or dialogue history.

The term “test input data” refers to one or more predetermined or dynamically generated inputs supplied to the chatbot for the purpose of evaluating the appropriateness, accuracy, or quality of the chatbot's responses.

The term “evaluation result” refers to information derived from analyzing the chatbot's responses to the test input data, the information indicating at least one of correctness, coherence, tone suitability, and other quality measures.

The term “learning data” refers to data used for training, fine-tuning, or adapting the generative AI model, including but not limited to question-and-answer pairs, dialogue logs, user feedback, and evaluation results.

The term “input text” refers to character-based information, such as words, sentences, or paragraphs, input by the user through a keyboard, touchscreen, or other text entry mechanism.

The term “voice data” refers to audio signals representing user speech, captured through a microphone or another audio input device.

The term “camera image data” refers to still images or video frames captured by a camera of the information processing device and provided as input for analysis.

The term “emotion” refers to a state or attitude of the user, such as happiness, sadness, anger, surprise, fear, or neutrality, identified by analyzing at least one of input text, voice data, and camera image data.

The term “emotion-appropriate response” refers to a response generated by the generative AI model that is adjusted in wording, tone, content, or style to suit the identified emotion of the user.

The term “dialogue history” refers to a record of past exchanges between the user and the chatbot, including at least prior user inputs, chatbot responses, timestamps, and associated metadata.

The term “custom response” refers to a response specified or configured by the user for a particular inquiry or condition, which is used by the processor to control or influence the output of the generative AI model.

The term “online environment” refers to an execution environment in which the chatbot and related services are accessible over a network, such as the Internet or a corporate intranet.

The term “local environment” refers to an execution environment in which the chatbot and related services are accessible within a local device or local network without requiring access to an external wide-area network.

The term “operation history” refers to data representing actions taken by a user when using the chatbot, including but not limited to queries entered, commands selected, response viewing behavior, and timestamps of such actions.

The term “interest” refers to a preference, concern, topic, or area of focus inferred for a user based on analysis of the operation history or other user behavior data.

The term “content being viewed” refers to media or information that the user is currently watching, reading, or otherwise consuming, including but not limited to videos, webpages, documents, and application screens.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

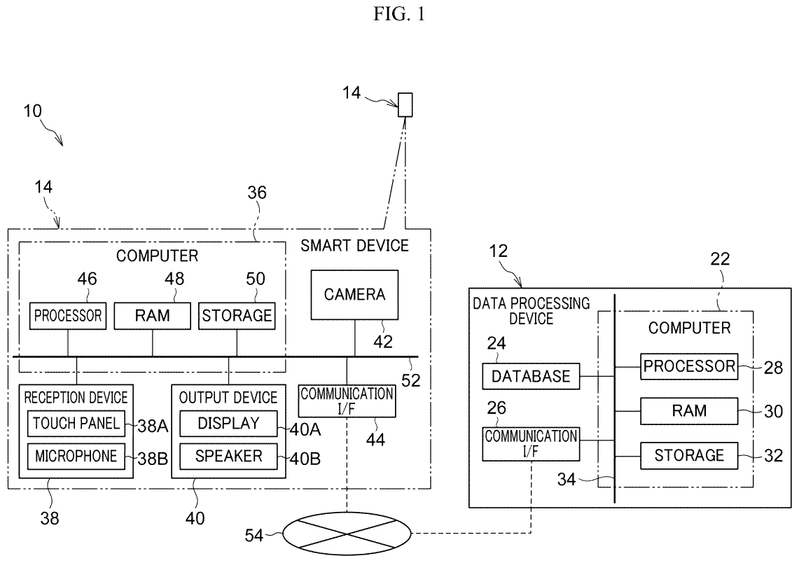

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

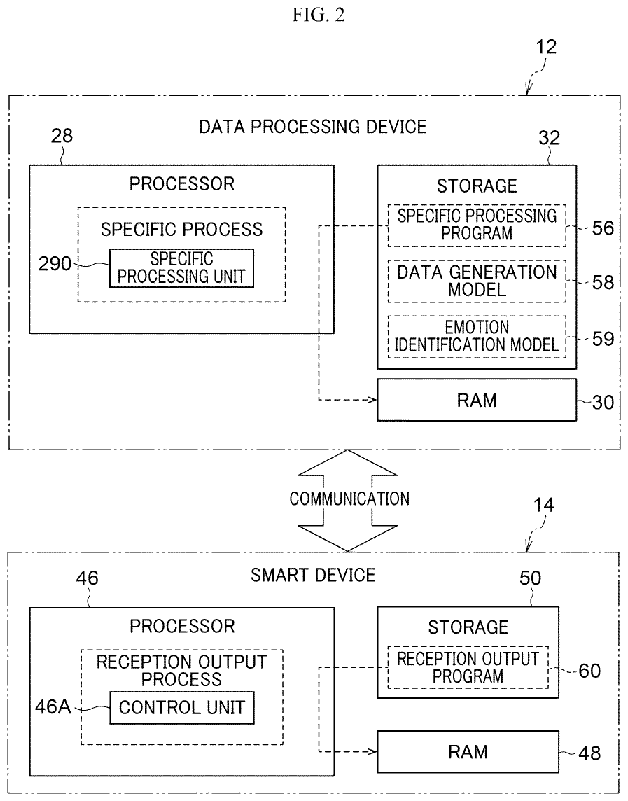

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that use a generative AI model typically treat the model as a static component that receives a prompt sentence and returns a response. In many such systems, the training data, the dialog logic, and the actual end-user interaction are loosely coupled or managed in separate tools. As a result, several technical problems arise in the operation of computer-based dialog systems.

First, it is technically difficult to update learning data of a generative AI model in a continuous and controlled manner based on real usage of dialog programs. In existing architectures, training data preparation, preprocessing, and model retraining are often performed offline by separate systems or human operators, without direct linkage to the configuration and behavior of deployed dialog programs. This separation leads to inefficiencies in data handling on servers and terminals, increases latency in reflecting user feedback, and makes it hard for computing resources to adapt to evolving user requirements.

Second, the configuration of dialog-type programs, including their purposes, response policies, constraint conditions, and example dialogs, is often handled by ad hoc scripting or rule engines that are not tightly integrated with the generative AI model. The server and the client devices do not have a standardized mechanism to transform high-level configuration information into concrete prompt sentences and system-level instructions used by the model.

This causes inconsistent behavior across different dialog programs, complicates state management and prompt construction on the server, and results in suboptimal utilization of computational resources such as processors and memory during inference.

Third, existing systems lack a unified computer-implemented pipeline for automatically evaluating responses of a deployed dialog program and feeding the evaluation back into the training process of the generative AI model. While some systems may log interactions, they often do not implement automated test input generation, response analysis using language-processing algorithms, and systematic generation of control information for updating training data and retraining conditions. This leads to a technical limitation where the model cannot be reliably improved based on operational data without manual intervention, thus reducing the effectiveness and efficiency of server-side learning processes.

Fourth, there is a technical challenge in making the generative AI model adapt to user-specific contexts, such as user interests inferred from operation history and dialog history, or user emotional states estimated from multimodal input data. Many conventional systems either ignore these signals or process them in a separate analytics layer that is not directly coupled with prompt construction for the generative AI model. Consequently, the computational pipeline from data acquisition on the terminal, through analysis on the server, to prompt generation and response adaptation is fragmented, leading to increased latency, redundant processing, and less accurate personalization in computer-implemented dialog systems. Fifth, because dialog-type programs are often deployed across heterogeneous environments, including local and network-connected devices, existing solutions do not provide a coherent server-centric mechanism to publish dialog programs, manage their identifiers and configuration, and deliver consistent AI-generated responses via a unified inference interface. This fragmentation complicates the implementation at the system level, increases the complexity of server logic for routing requests and maintaining dialog context, and makes it more difficult to scale and maintain the system.

Accordingly, there is a need for a computer-implemented technique that integrates, in a single server-centric architecture, (i) acquisition and uploading of training data from terminals; (ii) preprocessing and updating of learning data for a generative AI model; (iii) construction and registration of dialog-type programs based on structured configuration information; (iv) construction of prompt sentences for inference, including the use of dialog history, user interests, and emotional state; and (v) automated evaluation of dialog responses and feedback of evaluation results into training data updates. Such a technique should improve the efficiency and reliability of data processing, model training, prompt generation, and response delivery performed by the processor, thereby improving the operation of the computer system itself rather than merely automating a mental process.

The specific processing by the specific processing unit 290 of the data processing device 12 in Example 1 is realized by the following means.

The present invention provides a server comprising a processor and a memory storing instructions that, when executed by the processor, cause the server to receive, via an application or a network-based interface executed by an information processing apparatus, operations from a user for using a generative AI model; to receive from the information processing apparatus authentication information and training data selected by the user; to perform on the server, in response to the training data, integrity verification and preprocessing including format conversion, normalization, tokenization, and data splitting to generate training data suitable for updating learning data of the generative AI model; to perform, by executing a machine learning program on a numerical computation device, retraining or fine-tuning of the generative AI model using the training data and to store an updated generative AI model in a storage; to construct, based on configuration information including a purpose, a response policy, constraint conditions, and example dialogs received from the information processing apparatus, a dialog-type program including system-level instruction text, templates, and state management information, and to register the dialog-type program in association with the updated generative AI model; to receive from the information processing apparatus request data including a prompt sentence and dialog history together with an identifier of the dialog-type program; to construct, based on the identifier, the associated configuration information, and the dialog history, a prompt sentence for instructing the generative AI model to generate a response, to convert the prompt sentence into a token sequence, and to execute inference processing of the generative AI model to generate a natural language response by decoding and post-processing; and to perform automated evaluation by sequentially inputting test input data to the dialog-type program, analyzing responses using language analysis processing to generate control information, and updating the learning data and retraining conditions of the generative AI model based on the control information, and further to analyze user operation history and dialog history to estimate user interests and to automatically generate additional prompt sentences for adjusting responses or information to be presented. This enables an integrated, server-centric computational pipeline that continuously updates the generative AI model based on actual dialog usage, constructs and manages dialog-type programs as structured configurations, and dynamically generates and refines prompt sentences and responses based on user behavior and evaluation results, thereby improving the efficiency, adaptability, and technical performance of computer-based dialog systems.

The term “system” refers to a combination of one or more hardware devices and software components that cooperate to execute data processing operations, including at least one processor, a memory, communication interfaces, and storage.

The term “processor” refers to a hardware computation unit, such as a central processing unit or graphics processing unit, that executes machine-readable instructions to perform arithmetic, logical, control, and input/output operations.

The term “memory” refers to a volatile or non-volatile storage medium, such as random access memory or read-only memory, that stores instructions and data for access by the processor.

The term “storage” refers to a non-volatile information recording medium, such as a magnetic disk, optical disk, flash memory, or network-attached storage, used to store models, datasets, configuration information, and logs.

The term “server” refers to a computing apparatus or group of computing apparatuses that provide services to one or more external devices via a network and that execute backend processing including data preprocessing, model training, and inference.

The term “terminal” refers to an information processing apparatus operated by a user, such as a mobile device, portable device, or fixed client device, that executes an application or web interface to communicate with the server.

The term “information processing apparatus” refers to an electronic device that includes a processor and memory, and that performs input, processing, and output of data under control of software, including but not limited to mobile devices, tablet devices, and personal computers.

The term “application” refers to executable software running on an information processing apparatus that provides a user interface and communicates with the server via a communication protocol.

The term “network-based interface” refers to a user interface accessible over a communication network, such as a web interface rendered by a browser or a remote application interface, for transmitting and receiving data with the server.

The term “generative AI model” refers to a machine-learned model, typically based on a statistical or neural network architecture, that generates output data such as natural language text in response to input data, including a prompt sentence.

The term “learning data” refers to data used during training, retraining, or fine-tuning of a generative AI model, including input-output pairs, labels, and contextual information that determine parameter updates of the model.

The term “training data set” refers to a collection of learning data elements prepared for use in training, retraining, or fine-tuning of a generative AI model, typically stored as structured or semi-structured digital records.

The term “updated generative AI model” refers to a generative AI model whose parameters or configuration have been modified by retraining or fine-tuning using training data, such that the model behavior reflects the updated learning data.

The term “machine learning program” refers to software instructions that implement training, retraining, or inference of a machine-learned model, including data loading, forward computation, gradient computation, and parameter updating.

The term “numerical computation device” refers to hardware specialized or configured to perform high-speed arithmetic operations, such as a graphics processing unit, tensor processing unit, or vector processor used to accelerate machine learning computations.

The term “authentication information” refers to information used to verify the identity of a user or device, including credentials such as user identifiers, passwords, tokens, or cryptographic signatures.

The term “access right” refers to a permission or authorization state that determines which functions, data, or services a user or device is allowed to access within the system.

The term “configuration information” refers to structured data that defines operational characteristics of a dialog-type program, including its purpose, response policy, constraint conditions, example dialogs, and related parameters.

The term “dialog-type program” refers to a software component that manages interactive exchanges between a user and a generative AI model, including prompt construction, context handling, and response presentation.

The term “system-level instruction text” refers to a control string or meta-prompt that specifies global behavior, role, or constraints of a generative AI model in a dialog context and that is incorporated into prompt construction.

The term “template” refers to a predefined text or structural pattern used to systematically construct prompt sentences or responses by inserting variable content such as user input, context, or configuration parameters.

The term “state management information” refers to data structures and rules that represent and control the current and past states of a dialog session, including dialog history, active topics, and pending tasks.

The term “prompt sentence” refers to a sequence of characters or tokens provided as input to a generative AI model that instructs the model to generate a corresponding response.

The term “dialog history” refers to recorded information about past exchanges in a dialog session, including previous user inputs, previous system or model responses, and associated metadata.

The term “identifier” refers to data, such as a string or numeric value, that uniquely distinguishes an entity within the system, such as a dialog-type program, model instance, user, or dataset.

The term “token sequence” refers to an ordered list of discrete units, such as subwords, words, or symbols, obtained by tokenizing text and used as input to or output from a generative AI model.

The term “inference processing” refers to computation performed by a machine-learned model to produce output data from input data without changing the learned parameters of the model.

The term “decoding” refers to a process that converts probability distributions or token scores produced by a generative AI model into a concrete sequence of output tokens, using algorithms such as greedy selection, beam search, or sampling.

The term “post-processing” refers to processing applied to raw outputs of a generative AI model to obtain final outputs, including detokenization, formatting, filtering, and constraint enforcement.

The term “test input data set” refers to a collection of input data elements prepared for evaluating the behavior and performance of a dialog-type program and the underlying generative AI model.

The term “language analysis processing” refers to automated processing of text data using computational methods, such as parsing, semantic analysis, similarity measurement, or classification, to evaluate or characterize language content.

The term “control information” refers to data that specifies how to modify learning data, training conditions, or configuration parameters of a generative AI model or dialog-type program in response to evaluation results.

The term “operation history” refers to digital records of actions taken by a user within the system, such as inputs, selections, commands, and navigation events.

The term “user interest” refers to one or more topics, categories, or preferences inferred for a user based on operation history, dialog history, and other behavioral signals.

The term “emotional state” refers to an estimate of a user's affective condition, such as satisfaction, frustration, or curiosity, derived from input signals such as text, audio, or image data.

The term “test input data” refers to individual elements of a test input data set supplied to a dialog-type program for the purpose of evaluating its responses.

The term “quality indices” refers to one or more numerical or categorical measures used to assess response quality, such as relevance, coherence, politeness, or constraint compliance.

The term “constraint conditions” refers to rules or limitations governing the content or style of responses, such as prohibitions on certain topics or requirements for certain formats.

The term “example dialogs” refers to sample interactions composed of user inputs and desired system responses that illustrate the intended behavior of a dialog-type program.

The term “retraining conditions” refers to parameters or settings that govern how retraining or fine-tuning of a generative AI model is performed, such as data selection criteria, number of training iterations, or optimization hyperparameters.

The term “external apparatus” refers to any device separate from the server that communicates with the server over a network or local interface, including client devices used by end users.

The term “local environment” refers to a computing environment that is directly connected or co-located with the server or terminal, and that does not require a wide-area network for interaction.

The term “information to be presented” refers to content generated or selected by the system, such as explanatory text, recommendations, or answers, that is output to a user via a display, speaker, or other output device.

In an embodiment, a server, a terminal, and a user cooperate to implement a dialog-type system that updates, configures, and uses a generative AI model in a technically integrated manner.

### A. Overall Hardware and Software Configuration

The server executes one or more software modules on a hardware platform that includes at least one central processing unit (CPU), one or more graphics processing units (GPUs), a main memory, a non-volatile storage device, and a network interface. The server can be implemented on a general-purpose computer or a virtualized machine in a data center. The server can employ an operating system such as a general-purpose server operating system, a web server program, and a runtime environment for an application framework.

The server uses a machine learning framework such as a tensor-based computation library or a tensor-based neural network library to implement training and inference of the generative AI model. The server uses a GPU library, such as a parallel computation library and a deep neural network library, to accelerate matrix operations, convolution operations, and attention computations. The server further uses supporting libraries such as a numerical computation library, a data processing library, a text tokenization library, and a logging or experiment tracking library.

The terminal is implemented by an information processing apparatus, such as a smartphone, a tablet-type device, or a personal computer. The terminal includes a processor, a memory, a display unit, a communication interface, and input devices such as a touchscreen, a keyboard, and a microphone. The terminal executes a dedicated application or a web browser. The application can be implemented using a mobile application framework or a desktop framework.

The user operates the terminal to execute the application, perform login, select training data sets, configure dialog-type programs, and input prompt sentences to interact with the generative AI model via the server.

### B. Generative AI Model Structure and Learning Method

The server stores in the storage a generative AI model that is, in one embodiment, a transformer-based neural network configured for autoregressive language generation. The generative AI model includes:
an embedding layer that maps input token indices to dense vectors;
a stack of multiple transformer blocks, each transformer block including:
a multi-head self-attention module that computes attention weights among tokens, with each head computing scaled dot-product attention;
a position-wise feed-forward network composed of fully connected layers with non-linear activation;
residual connections and layer normalization units to stabilize training;
an output projection layer and a softmax layer that map hidden representations to a probability distribution over a vocabulary for each time step.

The server initializes the generative AI model parameters from a base model that has been pre-trained on large-scale text corpora. The server then performs fine-tuning or continual training using user-provided training data sets.

The server uses a loss function such as categorical cross-entropy between predicted token distributions and ground-truth token indices. The server uses an optimizer such as Adam or AdamW with adaptive learning rates, applies gradient-based parameter updates, and can apply techniques such as gradient clipping, learning rate scheduling, and weight decay. The server can apply data augmentation methods such as random truncation or context reordering, where appropriate, to improve robustness.

This configuration and training procedure differ from mere human rule-writing, because the server automatically adjusts thousands to billions of parameters based on numerical error gradients, which cannot be feasibly replicated by manual human work. The server uses vectorized operations and GPU parallelism to achieve orders-of-magnitude faster learning and inference compared to scalar operations.

### C. Data Structures and Internal Modules

The server maintains explicit data structures in memory and storage to manage training and inference:
A dataset registry that stores a dataset identifier, user identifier, file path, checksum, data schema, and preprocessing status for each training data set.
A model registry that stores model identifiers, model version, parameter file paths, associated dataset identifiers, training hyperparameters, and evaluation metrics.
A dialog program configuration store that stores dialog program identifiers, associated model identifiers, program name, purpose text, response policy description, constraint conditions, and example dialogs.
A session state store that records dialog history per user and per dialog program, including ordered pairs of user messages and system responses with timestamps and metadata.
A test scenario store that defines test input sets, expected constraints, and evaluation thresholds for automated testing.

The server modularizes processing into components:
A data ingestion module that receives and validates uploaded training data sets.
A preprocessing module that performs normalization, tokenization, and splitting.
A training controller that schedules and executes training jobs on numerical computation devices.
An inference controller that constructs prompt sentences, performs tokenization, calls the generative AI model, and post-processes responses.
An evaluation module that runs test input sets, computes quality metrics, and generates control information for retraining.
An analytics module that infers user interests from operation history and dialog history.
An emotion analysis module that estimates emotional states from text, audio, or image features using separate machine learning models such as recurrent neural networks, convolutional neural networks, or transformer encoders.

By explicitly structuring data and control in this way, the server avoids ad hoc, script-based integration and instead employs a defined module architecture that is optimized for computational efficiency and traceability.

### D. Training Data Acquisition and Preprocessing

The terminal enables the user to select a training data set stored on local storage or in a cloud storage service. The terminal reads metadata such as file size, file name, and mime type using operating system file APIs. The terminal then transmits the training data set to the server using a request with a body that may be encoded as multipart/form-data over a secure transport protocol.

The server stores the raw file temporarily and computes a checksum (for example, a cryptographic hash) to verify integrity. The server then applies a schema detection routine to parse the training data set. For example, when the file is in a tabular format, the server identifies columns such as “user_message” and “assistant_response”. When the file is in a structured text format, the server parses records that include fields for prompt sentences and associated replies.

The server converts the text fields into a unified internal representation. The server applies normalization procedures, including Unicode normalization, lowercasing when configured, removal or replacement of control characters, and standardization of whitespace. The server then applies a tokenizer consistent with the vocabulary and subword scheme of the generative AI model. The tokenizer may use a byte pair encoding, a unigram language model, or another subword segmentation algorithm.

The server segments the token sequences into training examples, each packaging a prompt and a target sequence. The server splits the data into training and validation sets using a pseudo-random partitioning algorithm to avoid bias. The server stores the preprocessed data in a format optimized for streaming input to the training framework, such as a binary record format or an indexed sequence file.

This preprocessing pipeline improves downstream computational efficiency by eliminating runtime parsing overhead and aligning token indices with the model's embedding table, thereby reducing memory access overhead and improving cache utilization during training and inference.

### E. Model Retraining and Technical Effect

The server reads a configuration associated with the selected training data set and determines hyperparameters such as batch size, maximum sequence length, learning rate, and number of training epochs. The server then spawns a training job that loads both the base model parameters and the preprocessed training data.

The server maps tensors to GPU memory and dispatches compute kernels for matrix multiplications, attention score computation, and activation operations. The server accumulates gradients over mini-batches and periodically updates the model weights. The server records training loss and evaluation metrics such as perplexity and distinctness of generated tokens.

Because the training is executed in a controlled environment with preprocessed data and specialized hardware, this embodiment achieves technical advantages over naive training:
Reduced training time per epoch due to optimized batching, pre-tokenized data, and GPU utilization.
Reduced memory fragmentation through pre-allocation of tensor buffers based on known sequence lengths.
Improved numerical stability due to normalization and carefully chosen hyperparameters and learning schedules.
More predictable and reproducible model performance because training runs are tied to explicit dataset and configuration identifiers.

These improvements directly affect the operation of the computer system by enabling more efficient use of GPUs and memory, faster convergence, and lower energy consumption per training run.

### F. Dialog Program Configuration and Prompt Construction

The user operates the terminal to define a new dialog-type program. The terminal displays input fields for program name, purpose, tone, constraints, and example dialogs. The user may specify text such as:
Purpose: “Explain the features of the new product line.”
Tone: “friendly and concise”
Constraint example: “Do not mention unreleased products.”
Example dialog:
User: “What are the main features of the new smartphone X100?”
Assistant: “The new X100 offers a 6.7-inch display, a multi-lens camera, 5G support, and a long-lasting battery.”

The terminal transmits the configuration to the server. The server converts the purpose, tone, and constraints into a system-level instruction text. For example, the server constructs an instruction text:
“You are a friendly and concise assistant that explains the features of the new product line and does not mention unreleased products.”

The server registers this instruction, together with the example dialogs, as part of the dialog program configuration. When the server later constructs prompt sentences for inference, the server concatenates:
the system-level instruction text;
a representation of the dialog history in which each turn is preceded by a role tag (for example, “User:” or “Assistant:”);
the current user input.

The server then tokenizes this composite text and feeds it to the generative AI model. This prompt construction process is rule-based and deterministic, and differs from ad hoc human composition; it enforces a consistent format that aligns with the model's training regime and thereby yields more stable responses and improved utilization of the context window.

### G. Inference and Response Generation

The user interacts with the dialog-type program by inputting prompt sentences through the terminal. The user may input, for example:
“Tell me the key features of the new smartphone model X100.”
or:
“Explain the main differences between the previous model X90 and the new model X100 for a customer who values camera performance.”

The terminal forwards these prompt sentences with associated dialog program identifiers and session identifiers to the server.

The server retrieves the relevant dialog program configuration and dialog history. The server constructs the full input text by inserting markers and role tags, for example:
“[System] You are a friendly and concise assistant that explains the features of the new product line and does not mention unreleased products.
[User] Tell me the key features of the new smartphone model X100.
[Assistant]”

The server tokenizes the text and feeds token IDs to the generative AI model. The server uses a decoding algorithm such as top-k sampling with temperature control, beam search, or nucleus sampling. The server may apply constraints within the decoding algorithm, such as banning sequences that mention unreleased products or enforcing specific output formats.

The server then converts the generated token sequence back to characters and produces a natural-language response. For example, the server outputs:
“The new smartphone model X100 features a 6.7-inch OLED display, a triple-lens camera with a high-resolution main sensor, next-generation wireless connectivity, and a battery designed to last throughout the day.”

The server performs post-processing such as trimming whitespace, correcting punctuation, and applying a content filter. The terminal receives the final response and displays it in a chat-style user interface.

This structured inference procedure, including standardized prompt construction and constraint-aware decoding, improves the technical quality of the generated outputs and reduces the need for post-hoc human editing, thereby enhancing overall system throughput and response latency.

### H. Automated Evaluation and Continual Improvement

The server stores test input sets and evaluation rules for each dialog-type program. The server generates test runs in which it supplies a variety of test prompt sentences to the dialog-type program, such as:
“Summarize the advantages of model X100 in three bullet points suitable for a sales brochure.”
or:
“Generate a polite email reply to a customer asking if the new model X100 is good for night photography.”

The server collects the resultant responses and applies language analysis processing. For instance, the server can:
parse the responses to verify that the required number of bullet points is present;
detect sentences mentioning banned terms or unreleased products;
compute similarity scores between generated responses and reference responses using embedding-based metrics.

The server aggregates evaluation metrics and compares them against thresholds. The server then generates control information specifying, for example, that the training data set should be augmented with additional examples in areas where performance is weak, or that the learning rate and number of training epochs should be adjusted.

When retraining is triggered, the server incorporates this control information into the training controller, thereby automatically adjusting learning conditions. This feedback loop is not a mere logging of results; it is a specific, machine-executed policy that maps evaluation outcomes to structured changes in training data and hyperparameters, which improves the technical performance of the generative AI model over time.

### I. User Interest and Emotion-Based Adaptation

The server records operation history and dialog history for each user. The server uses an analytics module to infer user interests by, for example, clustering topics based on term frequencies, embeddings of queries, and response categories. The server may infer that a given user frequently asks about camera performance or battery life.

The server uses this interest profile to adjust prompt construction. When the user submits a prompt sentence, such as:
“Is the camera good for night photography?”
the server can prepend additional guidance in the system-level instruction text, such as:
“Prioritize detailed explanations about camera performance, especially low-light photography, when relevant.”

In addition, when the user provides text, audio, or image input, the server can use a separate neural network model, such as a recurrent network for text sentiment classification or a convolutional network for facial expression analysis, to estimate an emotional state. The server then modifies the prompt sentence passed to the generative AI model, for example, by including directives such as “respond reassuringly and in a calm tone” when frustration is detected.

These adjustments are documented in the prompt sentence that is constructed algorithmically, and the generative AI model operates under these conditions. This approach is technically different from simply instructing a human operator; the server automatically transforms numeric and symbolic features representing user interest and emotional state into machine-readable prompts that influence the generative process in real time.

### J. Publication and Deployment of Dialog Programs

The server maintains mapping tables that link dialog program identifiers to deployment endpoints and access policies. When a dialog-type program is published, the server exposes an endpoint that external terminals can call, while enforcing authentication and rate limits.

The server reuses the same inference controller and model registry across multiple dialog programs. The server caches frequently used configurations and model weights in memory to avoid redundant loading from storage. This architecture reduces response latency and improves throughput, because the server minimizes disk I/O and leverages in-memory caching in combination with high-throughput GPU inference.

The terminal of another user can therefore access the published dialog-type program and obtain consistent responses, since the server centrally manages the dialog logic and the generative AI model.

### K. Technical Advantages and Alternative Embodiments

The server improves computer technology in several ways:
The server reduces end-to-end latency of dialog responses by integrating prompt construction, tokenization, inference, and post-processing in one optimized pipeline, and by using preprocessed and cached data structures.
The server improves accuracy and robustness of dialog responses by linking dialog program configurations, test evaluations, and retraining in a closed feedback loop that directly adjusts model parameters.
The server increases data management efficiency by maintaining explicit registries of datasets, models, and configurations, thereby enabling reproducible training runs and controlled incremental updates.

Alternative embodiments can vary the structure of the generative AI model. For example, the server can use an encoder-decoder architecture for sequence-to-sequence tasks, a mixture-of-experts architecture, or a hybrid model that incorporates retrieval-augmented generation by querying an external knowledge base during inference.

The server can also employ different tokenization schemes, such as character-level tokenization or wordpiece tokenization, and can incorporate additional features such as part-of-speech tags or domain-specific markers into the input representation.

The terminal can be implemented in different form factors, such as an in-vehicle system, a smart appliance, or a wearable device, so long as the terminal can communicate with the server and present dialog to the user. The same core mechanisms of data preprocessing, training, dialog configuration, prompt construction, inference, and evaluation remain applicable.

By executing these specific data flows, module interactions, and numerical procedures, the server and the terminal do more than automate human mental steps. They implement a concrete improvement to the functioning of computer-based dialog systems, including faster and more efficient utilization of numerical computation devices, more accurate and adaptive responses through technically structured feedback loops, and more efficient management and transformation of training data into optimized internal representations.

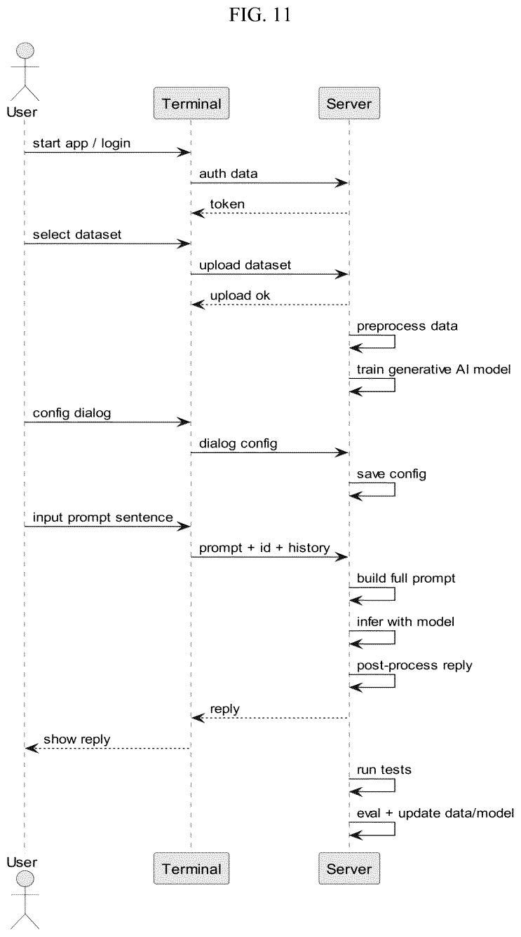

The following describes the processing flow using FIG. 11.

### Step 1

User starts the application on the terminal and initiates login.

User inputs authentication information such as a user identifier and a password using a touchscreen or keyboard of the terminal. The input of this step is raw credential text (identifier and password) entered by the user. The output of this step is structured authentication information stored in the memory of the terminal (for example, a key-value pair). Terminal formats the authentication information into a structured message, attaches device metadata (device type, OS version, application version), and transmits the message to the server via a secure communication protocol. Terminal performs data conversion from in-memory text objects to a serialized network payload.

### Step 2

Server receives authentication information and establishes an access right.

Server accepts the serialized authentication payload from the network interface and parses it into internal data structures in memory. The input of this step is the serialized authentication message from the terminal. The output is a validation result (success or failure) and, when successful, an access token or session identifier.

Server queries a user record store, retrieves a stored password hash for the provided identifier, and computes a hash of the received password using a password hashing algorithm. Server compares the computed hash with the stored hash. If the comparison matches, server generates a session token, registers the session token in a session store, and returns the session token to the terminal as a structured response.

### Step 3

User selects a training data set on the terminal.

User operates a file selection interface of the application and chooses one or more files that contain training data (for example, a text file or a tabular file including prompt sentences and responses). The input of this step is a set of file references available on the terminal or on an external storage service. The output is a selected training data set reference that includes file path, file name, and basic metadata.

Terminal reads file metadata using operating system APIs, checks file size and format, and prepares upload parameters such as chunk size and upload endpoint. Terminal does not yet transform the actual training content but prepares control information for subsequent upload.

### Step 4

Terminal uploads the selected training data set to the server.

Terminal opens the selected file, reads its raw bytes or text lines, and encapsulates the content into a network request body. The input of this step is the selected training data set file from local storage or cloud storage. The output is a network payload that streams the content to the server, together with metadata such as file name and data schema hint.

Terminal segments the file content into chunks if necessary, calculates a preliminary checksum if configured, and sends the data via secure communication to a dataset upload endpoint of the server. Terminal includes the access token in a header field so that the server can associate the upload with a user account.

### Step 5

Server ingests and stores the training data set.

Server receives the streamed file content through the network interface and writes the content to a temporary file in a storage area. The input of this step is the raw file stream and metadata sent from the terminal. The output is a persistent raw dataset file stored on the server and an associated dataset record in a dataset registry.

Server computes a cryptographic hash (for example, a fixed-length digest) over the entire file content to detect transmission errors or tampering. Server then stores the file path, file size, checksum, user identifier, and timestamp in a dataset registry. This registry entry becomes a reference for downstream preprocessing and training.

### Step 6

Server preprocesses the training data set for use by the generative AI model.

Server opens the stored raw dataset file and parses it according to its format (for example, parsing a delimited table into rows and columns, or parsing a structured text file into records of prompt sentences and target responses). The input of this step is the raw dataset file and its associated schema information. The output is a structured internal representation of text pairs and metadata ready for tokenization.

Server applies text normalization routines to each prompt sentence and response, including Unicode normalization, optional lowercasing, removal of control characters, and standardization of whitespace. Server then applies a tokenizer consistent with the generative AI model's vocabulary, converting each text string into a sequence of token identifiers and associated attention masks. Server splits the structured data into a training subset and a validation subset using a pseudo-random partition function. Server writes the tokenized and partitioned sequences into a training data format optimized for streaming, such as binary record files or indexed sequence files, and updates the dataset registry to mark preprocessing completion.

### Step 7

Server schedules and executes retraining or fine-tuning of the generative AI model.

Server reads training configuration parameters for the selected dataset, including a choice of base model, batch size, learning rate, number of epochs, and maximum sequence length. The input of this step is the preprocessed training data and the training configuration. The output is an updated generative AI model stored in the model registry.

Server allocates a numerical computation device, such as a GPU, loads the base generative AI model parameters into GPU memory, and creates data loaders that fetch tokenized sequences in mini-batches. Server performs iterative training steps in which, for each batch, it computes forward passes through the transformer blocks, calculates a loss value using a cross-entropy function, computes gradients via backpropagation, and updates weights with an optimizer such as Adam. Server periodically evaluates the model on the validation subset, logs metrics, and saves checkpoints. At the end of training, server selects the best-performing checkpoint as the updated generative AI model and registers a new model identifier in the model registry.

### Step 8

User configures a dialog-type program on the terminal.

User opens a configuration interface of the application and specifies parameters such as program name, purpose, tone, constraint conditions, and example dialogs. The input of this step is user-entered configuration text and selection of an updated generative AI model. The output is a configuration object that fully describes a dialog-type program.

Terminal structures the configuration text into fields, associates the selected updated generative AI model identifier, and sends this configuration object to the server using a network request. Terminal transforms free-form user text into a structured payload that the server can process deterministically.

### Step 9

Server constructs and registers the dialog-type program.

Server receives the configuration object and parses its fields into internal representations. The input of this step is the dialog configuration information and an associated model identifier. The output is a registered dialog-type program entry with a unique program identifier. Server synthesizes a system-level instruction text by combining the purpose, tone, and constraints into a single control string. Server stores the instruction text, example dialogs, and links to the model identifier in the dialog program configuration store. Server generates and stores a unique program identifier and initializes state management structures so that dialog histories can later be associated with this program.

### Step 10

User initiates a dialog and sends a prompt sentence from the terminal.

User selects a dialog-type program via the application and enters a prompt sentence in a text input field. For example, the user may input:
“Tell me the key features of the new smartphone model X100.”
or:
“Explain the main differences between the previous model X90 and the new model X100 for a customer who values camera performance.”

The input of this step is raw natural-language text typed by the user. The output is a structured request containing the prompt sentence, the dialog program identifier, and a dialog session identifier.

Terminal encapsulates the prompt sentence and identifiers into a request object, optionally including recent dialog history stored locally, and transmits the object to the server via a secure network connection. Terminal converts the text and identifiers into a serialized form suitable for network transport.

### Step 11

Server constructs an extended prompt for the generative AI model.

Server receives the request object and retrieves the dialog-type program configuration and any stored dialog history from the session state store. The input of this step is the user's prompt sentence, the associated dialog program identifier, configuration information, and dialog history. The output is an extended prompt text that incorporates instructions, history, and current input.

Server concatenates the system-level instruction text, formatted past dialog turns (with explicit role markers such as “User” and “Assistant”), and the current user prompt sentence into a single text buffer. Server may also append additional clauses based on inferred user interest or emotional state, for example, adding guidance to emphasize camera performance or to respond in a reassuring tone. Server then passes this extended text to the tokenization module, which converts the text into one or more sequences of token identifiers and positional encodings that are valid inputs for the generative AI model.

### Step 12

Server performs inference with the generative AI model to generate a response.

Server feeds the token sequences derived from the extended prompt into the generative AI model's input layer. The input of this step is the tokenized extended prompt. The output is a generated token sequence representing the assistant's response.

Server executes a forward pass through the transformer layers, computing attention weights, intermediate hidden states, and output logits for each vocabulary token at each time step.

Server applies a decoding algorithm, such as beam search or top-k sampling with a temperature parameter, to iteratively select output tokens based on the logits and defined constraints. Server may prevent certain tokens or phrases from being generated by masking them during decoding, for example, to avoid mention of unreleased products. The resulting sequence of output token identifiers is then converted back into a text string via the tokenizer's detokenization function.

### Step 13

Server post-processes and returns the generated response.

Server takes the raw generated text and applies post-processing rules. The input of this step is the detokenized candidate response text. The output is a finalized response text that conforms to format and content constraints.

Server removes leading and trailing whitespace, corrects spacing around punctuation as configured, and may apply content filters that remove or replace disallowed terms according to constraint conditions stored in the dialog configuration. Server then packages the finalized response together with metadata such as token usage statistics and an updated dialog history reference into a response object, and transmits the response to the terminal over the network.

### Step 14

Terminal displays the response and updates local dialog history.

Terminal receives the response object and parses the included fields into application data structures. The input of this step is the structured response including the generated text and updated history. The output is a rendered chat display on the terminal and an updated local copy of the dialog history.

Terminal displays the generated text in a chat-like interface, associating it with the corresponding user input. Terminal stores the new dialog turn locally, in a log or database, and optionally synchronizes it with server-side session state. This local storage enables the terminal to reconstruct conversation context and present a continuous user interface even when network connectivity temporarily fluctuates.

### Step 15

Server executes automated testing and evaluation of the dialog-type program.

Server periodically or on demand selects a set of predefined test prompt sentences from the test scenario store, for example:
“Summarize the advantages of model X100 in three bullet points suitable for a sales brochure.”
“Generate a polite email reply to a customer asking if the new model X100 is good for night photography.”

The input of this step is the test input set and the dialog program configuration. The output is a collection of evaluation metrics and control information for retraining.

Server feeds each test prompt into the dialog-type program, runs the full inference pipeline, and collects generated responses. Server then applies language analysis algorithms, such as pattern matching to ensure presence of a specific number of bullet points, semantic similarity scoring, and violation detection against constraint rules. Server aggregates scores and generates control information describing how to adjust training data (for example, add more examples on a certain topic) or training hyperparameters (for example, modify learning rate or number of epochs).

### Step 16

Server updates learning data and retraining conditions based on evaluation.

Server interprets the control information as instructions to modify the dataset registry and training configuration entries. The input of this step is the control information derived from evaluation results. The output is updated learning data selections and updated retraining policies.

Server may mark specific training examples as high-importance, add new synthetic training pairs constructed from test prompts and corrected responses, or exclude undesirable patterns identified as causing poor performance. Server updates training configuration parameters, such as enabling additional epochs or adjusting sampling strategies. In subsequent retraining runs, these changes cause the generative AI model to reduce errors observed during testing, leading to measurable improvements in response quality and technical performance of the entire system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems and content delivery systems that employ generative AI models largely treat each user request as an isolated input and generate responses based only on the immediate prompt sentence. Such systems typically do not incorporate structured, per-user feedback and usage history into systematic training data updates or prompt construction rules. As a result, the underlying generative AI model and its associated prompt engineering logic are not effectively adapted to the evolving interests, preferences, and emotional states of individual users, and the overall relevance and usefulness of generated responses remain limited.

In many existing architectures, model inference is performed as a black-box operation: a prompt is sent to a generative AI model hosted on a remote computing resource, and a response is returned. The server or backend logic does not robustly associate each prompt sentence and response with user evaluation data, nor does it maintain a time-series response history that can be used to dynamically adjust prompt construction, model selection, or response ordering. This results in static behavior that fails to leverage rich behavioral signals captured by information processing terminals such as smartphones, tablet devices, and personal computers.

Furthermore, conventional systems do not adequately integrate multi-modal user data (for example, text, audio, or image data) and emotion recognition into the generative AI model control flow. Even if user emotion is detected, the linkage between such detection and the construction of a prompt sentence that explicitly constrains the generative AI model to generate emotion-adapted responses is weak or absent. This leads to responses that may be technically correct but are not contextually or emotionally appropriate from the user's perspective.

Another problem is that the training of generative AI models, or the adjustment of their output tendencies, is typically performed offline and decoupled from real-world usage of deployed chatbots. Test inputs and evaluation of chatbot responses are often performed manually and are not systematically tied back into the training data sets used to fine-tune the models or to update prompt construction rules. Accordingly, the system cannot efficiently exploit continuous feedback loops to improve dialog quality, information recommendation accuracy, and user satisfaction.

From the standpoint of computer technology, there is a need for a server-side architecture and processing logic that: (i) captures user interaction data and evaluation data in a structured and time-series manner; (ii) uses such data to update training data sets or prompt construction rules for a generative AI model; (iii) dynamically modifies prompt sentences, model selection conditions, and response presentation order based on response history information; and (iv) coordinates external or internal training processing resources to adjust the generative AI model. Without such an integrated mechanism, computer systems cannot fully exploit generative AI capabilities to provide adaptive, high-quality dialog behavior and personalized information provision while efficiently utilizing computational resources.

The specific processing by the specific processing unit 290 of the data processing device 12 in Application Example 1 is realized by the following means.

The present invention provides a server comprising a processor configured to receive, via an application or an information presentation screen provided by an information processing terminal, input from a user including a request content and an operation to make a generative AI model available; analyze input data including the request content acquired from the information processing terminal; construct a prompt sentence for causing the generative AI model to generate a response; transmit the prompt sentence to the generative AI model and obtain response data generated by the generative AI model; configure, on the basis of the response data, an automatic response function providing dialog-format responses and publish the automatic response function via a communication path or storage resource so that other users are able to use the automatic response function; transmit test input data to the automatic response function, analyze test response data generated by the automatic response function, and generate control information for updating a training data set of the generative AI model; acquire at least one of user text data, user acoustic data, or user image data and analyze the acquired data by using an identification information processing model to specify an emotional state of the user, construct a prompt sentence for causing the generative AI model to generate a response adapted to the emotional state, and optimize the response based on the prompt sentence; receive individual response settings for specific inquiries on the basis of a dialog history and construct a prompt sentence for causing the generative AI model to generate a response having specific content in accordance with a control condition including the individual response settings; collect operation history data of a plurality of users using the automatic response function, analyze the operation history data to specify interest information of each user or a user group, construct a prompt sentence for causing the generative AI model to generate provision information based on the specified interest information, and present the provision information via the information processing terminal; identify content being viewed by the user and construct a prompt sentence for instructing the generative AI model to extract or generate related information so as to acquire additional information related to the viewed content; acquire user evaluation data transmitted from the information processing terminal, store the user evaluation data in association with the request content, the prompt sentence, and the response data of the generative AI model, execute a learning control process for updating at least one of the training data set of the generative AI model or a rule for constructing the prompt sentence based on an accumulated history of responses accompanied by evaluations, and improve relevance and usefulness of subsequent response generation processing by using an update result; and control an external training information processing apparatus or an internal training processing function to execute an adjustment or fine-tuning process of the generative AI model on the basis of a training data set generated from the user evaluation data, the request content, and the response data, and reflect an adjusted generative AI model or the rule for constructing the prompt sentence in the response generation processing. This enables a computer-implemented dialog and information provision system to form closed feedback loops between user interactions and generative AI model behavior, to dynamically adapt prompt construction and model selection based on time-series response history, and to continually improve response quality, personalization, and emotional appropriateness through systematic updates of training data sets and model parameters.

The term “system” refers to a combination of hardware resources and software components that cooperate to execute information processing functions as claimed.

The term “server” refers to an information processing apparatus, typically including at least one processor, memory, and communication interface, configured to provide services to one or more remote information processing terminals over a communication network.

The term “processor” refers to one or more hardware processing units, such as a central processing unit or a graphics processing unit, that execute instructions to perform the operations and control functions described in the claims.

The term “information processing terminal” refers to an electronic device, such as a mobile device, a tablet device, or a personal computer, that includes input and output interfaces and is capable of executing an application or presenting a web-based user interface.

The term “application” refers to software executed on an information processing terminal that provides a user interface and communication functions for interacting with the server and the generative AI model.

The term “information presentation screen” refers to a graphical user interface displayed on an information processing terminal for presenting content to a user and accepting user input.

The term “user input” refers to data provided by a user through an input interface, including at least one of text, audio, image, or gesture information, which is processed by the system.

The term “request content” refers to information included in user input that specifies a topic, question, instruction, or other subject matter for which the user desires a response or information from the generative AI model.

The term “generative AI model” refers to a machine learning model, such as a neural network-based language model, configured to generate output data, including text or other content, in response to input data.

The term “prompt sentence” refers to a text string or structured text data constructed by the server on the basis of the request content and other control information, and used as an input to the generative AI model to control generation of a response.

The term “response data” refers to output information generated by the generative AI model in response to a prompt sentence, including at least textual content suitable for presentation to a user.

The term “automatic response function” refers to a software-implemented function that uses the generative AI model to automatically generate and provide dialog-format responses to user inputs without requiring manual authoring of each response.

The term “communication path” refers to a logical or physical communication channel, including at least one of a network connection, a communication protocol, or an interface, through which data is transmitted between the server and other devices.

The term “storage resource” refers to a memory or storage device, such as a database, a file system, or a storage service, used for storing data including prompts, responses, user histories, and models.

The term “test input data” refers to one or more predefined or generated input samples supplied to the automatic response function for evaluation of response behavior and quality.

The term “test response data” refers to responses generated by the automatic response function when the test input data is applied, and used for analysis and evaluation purposes.

The term “control information” refers to data derived from analysis of responses and evaluations, used to configure, update, or adjust at least one of a training data set, a model parameter, or a prompt construction rule of the generative AI model.

The term “training data set” refers to a collection of data items, each including at least an input portion and an associated desired output or evaluation label, used to train or fine-tune the generative AI model.

The term “user text data” refers to character-based input data provided by a user, such as typed or transcribed text.

The term “user acoustic data” refers to audio-based input data provided by a user, such as speech captured by a microphone.

The term “user image data” refers to visual input data including still images or video frames capturing at least part of a user or a user environment.

The term “identification information processing model” refers to an information processing model, such as a machine learning classifier, configured to analyze input data and identify attributes including at least an emotional state.

The term “emotional state” refers to an inferred state of a user's affect or sentiment, such as happiness, sadness, anger, or neutrality, determined by analysis of user data.

The term “individual response setting” refers to configuration information specified by a user or administrator that defines a preferred or custom response to a particular inquiry or condition.

The term “dialog history” refers to stored information representing a sequence of past exchanges between a user and the automatic response function, including prompts, responses, and associated context.

The term “operation history data” refers to recorded data representing operations performed by users when interacting with the automatic response function, such as inputs, selections, navigation actions, and timestamps.

The term “interest information” refers to data representing topics, categories, or preferences inferred or specified for a user or user group based on operation history data or other signals.

The term “provision information” refers to information selected or generated for presentation to a user on the basis of interest information or other personalization criteria.

The term “viewing target content” refers to content, such as a document, a video, an image, or a web page, that is currently being viewed or consumed by a user on an information processing terminal.

The term “related information” refers to information that has a semantic, topical, or contextual relationship to viewing target content, and is generated or extracted for supplemental presentation.

The term “user evaluation data” refers to explicit or implicit feedback data provided by a user regarding the quality, relevance, or usefulness of a response, including ratings, binary judgments, or interaction-based signals.

The term “response history” refers to accumulated data including prompt sentences, response data, and user evaluation data associated with those prompts and responses, stored in temporal order.

The term “prompt construction rule” refers to a rule set or algorithm used by the server to determine how to assemble, modify, or augment a prompt sentence from request content and other context or control information.

The term “learning control process” refers to a sequence of operations in which the server analyzes response history and user evaluation data to update at least one of a training data set, model parameters, or prompt construction rules.

The term “output tendency” refers to a statistical or behavioral characteristic of the generative AI model's outputs, such as style, level of detail, or topic emphasis, conditioned on given inputs.

The term “external training information processing apparatus” refers to a computing resource separate from the server, configured to perform training or fine-tuning processes on the generative AI model using a training data set.

The term “internal training processing function” refers to a training or fine-tuning capability implemented within the server or within a computing environment directly controlled by the server.

The term “adjustment process” refers to a process for modifying one or more parameters or configurations of the generative AI model so as to change its output behavior.

The term “fine-tuning process” refers to a training procedure in which an already trained generative AI model is further trained on an additional training data set to adapt the model to specific tasks, domains, or user preferences.

The term “model selection condition” refers to criteria used to select one generative AI model or configuration among multiple available models or configurations for processing a given request.

The term “response presentation order” refers to an order or priority in which multiple candidate responses or information items are presented to a user.

The term “time series” refers to an ordering of data items according to temporal information such as timestamps, enabling chronological analysis of interactions and system behavior.

The term “information provision processing” refers to processing that selects, generates, and outputs information to a user through an information processing terminal on the basis of request content, interest information, or other context.

In one embodiment, a server cooperates with one or more terminals operated by users to provide dialog responses and information provision using a generative AI model. The server includes at least one central processing unit, a main memory, a non-volatile storage device such as a solid-state drive, and a network interface connected to a communication network. The terminal includes a processor, a display, an input interface such as a touch panel or keyboard, and a communication module such as a wireless transceiver. The server executes server-side software implemented on an operating system such as a general-purpose server operating system. The terminal executes client-side software, such as a mobile application or web application, implemented for example using a cross-platform user interface framework.

The terminal provides a graphical user interface that enables the user to input natural language requests. The terminal uses an input subsystem provided by a mobile or desktop operating system to convert key presses or touch inputs into Unicode text strings. The terminal stores the text in an internal data structure, such as a string buffer managed by a user interface framework, and visually displays the text in a text input field. The user may input, for example, the following prompt sentence:
“Please tell me the latest technology news, especially about AI and robotics.”

The terminal sends the prompt sentence to the server through a network connection, using a transport protocol such as HTTPS. The terminal constructs a request message including fields such as a user identifier, a timestamp, and the prompt sentence. The terminal encodes the message as a structured text object such as a JSON-like payload and transmits it to an application programming interface endpoint provided by the server.

The server receives the request message using a web service framework. The server parses the structured payload to extract the prompt sentence, the user identifier, and other metadata. The server stores these elements in memory in record form, for example as objects having fields “prompt”, “userId”, and “timestamp”. The server applies preprocessing to the prompt sentence, such as trimming whitespace, normalizing character encoding, and segmenting the text into tokens using a tokenizer that is compatible with the generative AI model. The server may also append control prefixes and contextual information to form an extended prompt sentence, for example:
“You are a news assistant. Generate a concise and up-to-date explanation. User request: Please tell me the latest technology news, especially about AI and robotics.”

The server interfaces with a generative AI model implemented as a transformer-based neural network. In one embodiment, the generative AI model includes an embedding layer that maps tokens to dense vectors, a plurality of transformer blocks each including multi-head self-attention layers and feed-forward layers, and an output projection layer that maps hidden states to token probability distributions. The generative AI model is stored on a computing resource that may be external to the server or local to the server. The server converts the tokenized prompt sentence into an index sequence and supplies the sequence to the generative AI model along with generation parameters such as maximum output length, temperature, and top-k or top-p sampling parameters.

The generative AI model receives the sequence of token indices and computes, in each transformer block, attention scores using query, key, and value matrices. The model multiplies the attention weights with value vectors to obtain context-aware representations and propagates the representations through non-linear feed-forward networks. The model generates output token distributions step-by-step by applying a softmax function to the output logits. The model selects tokens according to the configured sampling algorithm and thus forms a generated text sequence as response data. The server receives the generated token sequence and converts it back into a textual response using a vocabulary mapping.

The server performs post-processing on the generated text, such as removing incomplete sentences at the end, applying content filters, and partitioning the text into paragraphs for display. The server stores the prompt sentence, the generated response text, the generation parameters, and a content identifier in a persistent data store. The server then sends the generated response text and associated metadata back to the terminal using a response message.

The terminal receives the response message, parses the content, and updates the user interface. The terminal displays the generated response text in a scrollable view. The user can read the response and evaluate whether the text satisfies the request. The terminal may display rating controls such as star icons, thumbs-up and thumbs-down buttons, or a slider control.

The user operates the rating control on the terminal to provide user evaluation data. The terminal converts the user's interaction into an evaluation value, for example an integer rating or a binary value, and associates the value with the content identifier and the original prompt sentence. The terminal sends the user evaluation data to the server in a separate feedback message. The message may include, in addition to the evaluation value, contextual information such as the response text identifier, the user identifier, and a timestamp.

The server receives and parses the feedback message. The server stores the user evaluation data in a structured database, associating the evaluation record with the corresponding prompt sentence and response data. The server maintains response history information in a time-series manner by storing, for each interaction, a record containing at least the prompt sentence, the generated response text, the generation parameters, and the user evaluation value. The server can query this response history by user, by topic, or by model configuration.

The server analyzes the accumulated response history to derive interest information and to classify responses as preferred examples or non-preferred examples. The server can execute a batch process that aggregates evaluation values for each cluster of prompts sharing similar topics, which the server may detect by applying a topic modeling algorithm or an embedding-based similarity measure. The server labels responses with high evaluation values as positive samples and responses with low evaluation values as negative samples and creates a training data set that includes triplets of (prompt sentence, response text, evaluation label).

The server uses the training data set to perform an adjustment process or a fine-tuning process on the generative AI model. In one embodiment, the server constructs a loss function that penalizes the likelihood of negative sample responses and rewards the likelihood of positive sample responses. For example, the server may employ a cross-entropy loss over preferred responses or a pairwise ranking loss between preferred and non-preferred responses. The server may perform gradient descent optimization using stochastic batches of training samples, and update the model weights in the transformer layers. The server may also perform data augmentation by paraphrasing prompts or responses using deterministic transformations, thereby increasing the diversity of the training set.

The server can execute the fine-tuning process on an external training information processing apparatus equipped with accelerator hardware such as graphics processing units. The server prepares the training data set in a file format such as line-delimited text with prompt and response fields and transfers this file to the external apparatus. The external apparatus loads the pre-trained generative AI model, applies the fine-tuning algorithm, and saves an updated model file. The server then deploys the updated model file to an inference environment or updates a pointer from the server to a new model endpoint.

The server also adjusts prompt construction rules based on the response history. For example, the server may observe that prompts including explicit emotional context yield higher evaluation scores. In such a case, the server modifies a rule table that determines how to assemble prompt sentences. The server may add explicit tags describing user emotion or interest, may insert constraints about desired output length, or may change the ordering of system instructions and user text. The server stores these rules in a configuration repository and applies them when constructing new prompt sentences.

The server further uses multi-modal user data to adjust responses. When the terminal sends user acoustic data or user image data, the server applies an identification information processing model such as a convolutional neural network or a recurrent neural network to extract features correlated with emotion. The server may first perform preprocessing such as converting audio into a mel-spectrogram and normalizing image data. The identification model outputs a probability distribution over emotional categories. The server then encodes the detected emotional state into a symbolic tag, such as “[EMOTION: JOY]” or

“[EMOTION: SADNESS]”, and appends this tag to the prompt sentence. This allows the generative AI model to condition its output on the emotional state without the user explicitly describing the emotion.

The terminal can additionally provide content context to the server. For example, when the user is viewing a news article, a video, or a web page, the terminal detects the identifier or title of the content and sends it to the server. The server may retrieve a summary or metadata of the viewing target content and insert it into the prompt sentence as a contextual block such as:
“Context: The user is currently reading an article about recent advances in AI and robotics. User request: Please tell me the latest technology news, especially about AI and robotics.”

By including explicit context and emotional tags, the system modifies the input to the generative AI model in a way that is not achievable by manual human response generation alone and is not a mere replacement of human speech. The server orchestrates the entire data path, from the collection of multi-modal signals to the construction of structured prompt sentences and the capturing of evaluation feedback, using machine-readable data structures and configurable algorithms.

The server leverages the continuous flow of evaluation data and interaction logs to improve computational efficiency and output quality. For example, when certain types of prompts or topics repeatedly generate low-rated responses, the server can adaptively select a different model configuration with more capacity or a specialized sub-model. The server may maintain multiple generative AI models, such as a general-purpose model and a domain-specific model, and select among them based on keywords, topic embeddings, or user profile data. This model selection condition is computed algorithmically and applied automatically, thereby reducing the number of ineffective model invocations and improving average response quality. The system provides technical effects in terms of processing speed and resource usage. Because the server records fine-grained interaction data and automatically learns which prompt construction patterns and model configurations yield better evaluations, the server can avoid redundant exploration and converge on efficient strategies. This decreases the average number of tokens generated per successful response and can reduce network traffic and inference time per interaction. Additionally, by training the generative AI model with user-driven preference labels, the model can produce relevant answers with fewer back-and-forth clarifying exchanges, reducing overall message volume between the terminal and the server. The system also improves data management by structuring interaction data into linked entities: prompt records, response records, evaluation records, and context records. The server stores these entities in a database in which each record contains identifiers that link to related records. This structured form enables efficient retrieval and analysis using indexed queries.

The server can perform time-series analysis and trend detection on this database to adapt processing behavior. This is a specific technical solution that improves how computer systems handle large volumes of dialog data, not merely an automation of manual log review.

The server uses non-conventional rules and procedures that differ from straightforward rule-based chatbots or simple log collection. For instance, the server may apply a ranking algorithm that orders candidate prompt variants before sending any query to the generative AI model, using learned scores derived from historical performance. The server may create multiple candidate prompt sentences for the same user request, each differing by system instructions, emotional tags, or contextual details, and then select only the top-ranked prompt to send to the model. This pre-selection reduces redundant computation and applies learned heuristics that are not intuitive for a human operator to manage manually.

The system further supports multiple implementation variations. In another embodiment, the server does not fine-tune the core generative AI model but instead learns a smaller adapter network or a bias vector that post-processes model logits before sampling. The server trains the adapter using the same evaluation-driven training data set, thereby altering the output tendency of the model with fewer parameters and less computational cost. Alternatively, the server may learn a re-ranking model that evaluates candidate responses generated by the generative AI model and selects the best candidate according to features such as semantic similarity to the prompt, sentiment alignment with the user's emotional state, and historical performance metrics.

The terminal can also be implemented as a web browser executing client-side scripts rather than a native application. In such a configuration, the client-side script uses browser APIs to capture user input and evaluation data and uses web communication protocols to interact with the server. The core functions of capturing prompts, transmitting them, displaying responses, and gathering feedback remain consistent across terminal implementations.

The described system improves computer technology in several ways. The system introduces a closed-loop architecture that tightly couples inference, feedback collection, training data construction, and model or prompt updating. This architecture enables the generative AI model to adapt at runtime or near-runtime to the observed behavior of many users, optimizing both accuracy and efficiency. The explicit modeling and exploitation of time-series response history, multi-modal emotional states, and context-aware prompt construction rules constitute specific technical mechanisms that directly affect how the server processes data and controls generative AI computation. The improvements are realized in machine-level operations—such as how data structures are organized in memory, how model parameters are updated, and how network requests are optimized for reduced redundancy—and are not limited to simplifying a human administrative task.

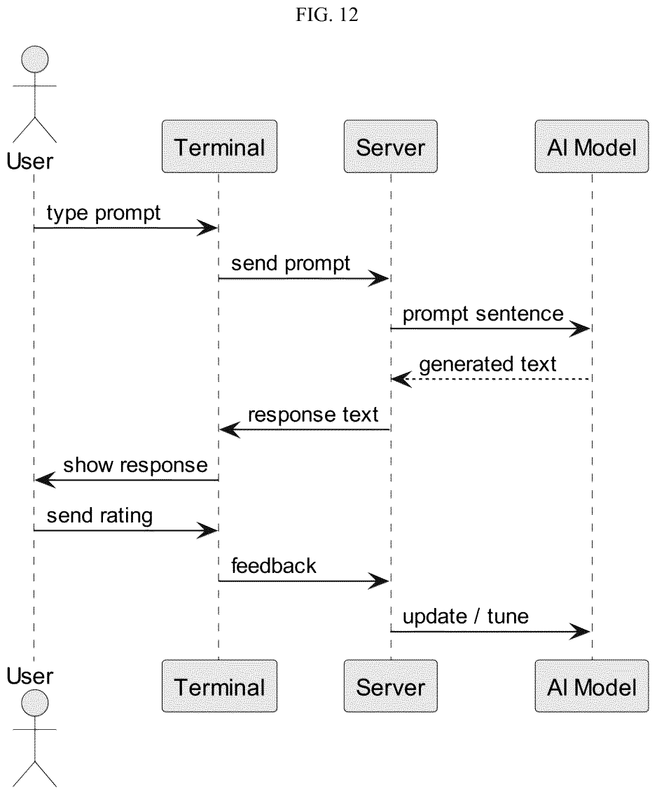

The following describes the processing flow using FIG. 12.

### Step 1

The user operates the terminal to start an interaction. The user launches an application or web interface on the terminal and navigates to a screen providing a text input field. The input of this step is a sequence of keystrokes or touch events captured by the operating system's input subsystem. The terminal converts these events into a Unicode text string representing a prompt sentence, such as “Please tell me the latest technology news, especially about AI and robotics.” The terminal stores this string in an internal variable of the application and updates the display so that the full prompt sentence is visible to the user as the current input. The output of this step is a structured prompt object in the terminal memory that includes the text string and optional metadata such as a local timestamp.

### Step 2

The terminal validates and prepares the prompt sentence for transmission. The input of this step is the prompt object generated in Step 1. The terminal checks whether the prompt sentence is non-empty and within a predefined maximum length, trims leading and trailing spaces, and normalizes newline characters. If the validation fails, the terminal displays an error message and requests correction; if it succeeds, the terminal constructs a request payload including fields such as the prompt sentence, a terminal identifier, a user identifier (if available), and a timestamp. The terminal encodes this payload as a structured text message, for example a JSON-formatted string. The output of this step is a network-ready request message containing the cleaned prompt sentence and associated metadata.

### Step 3

The terminal sends the prepared prompt sentence to the server. The input of this step is the request message produced in Step 2. The terminal uses a communication library to open a secure connection (for example, HTTPS) to a predefined server endpoint and sets protocol headers such as content type and authorization information. The terminal then writes the request message into the network socket buffer and triggers transmission over a wireless or wired network. While waiting for a response, the terminal updates the user interface to show a loading indicator, such as a spinner or “Generating . . . ” text. The output of this step is a network packet sequence carrying the request message from the terminal to the server.

### Step 4

The server receives and parses the user request. The input of this step is the incoming network packet sequence that encodes the request message. The server's network stack reconstructs the HTTP request, and a web framework on the server routes the request to a handler function.

The server reads the request body and parses the structured data, extracting fields such as the prompt sentence, the user identifier, and the timestamp. The server stores these values in working memory as a request record. The output of this step is an internal representation of the user request, including the raw prompt sentence ready for further processing.

### Step 5

The server preprocesses the prompt sentence and constructs an extended prompt sentence. The input of this step is the raw prompt sentence and associated metadata from Step 4. The server performs normalization operations such as trimming, lowercasing where appropriate, and converting the text to a unified character encoding. The server may additionally detect the language of the prompt or identify keywords using a tokenizer and simple natural language processing functions. Based on configuration rules and user context, the server constructs an extended prompt sentence by concatenating system instructions, contextual information, and the user's prompt, for example: “You are a news assistant. Generate a concise and up-to-date explanation. User request: Please tell me the latest technology news, especially about AI and robotics.” The output of this step is a finalized prompt sentence that acts as input to the generative AI model.

### Step 6

The server converts the finalized prompt sentence into a token sequence for the generative AI model. The input of this step is the extended prompt sentence from Step 5. The server applies a tokenizer compatible with the generative AI model to segment the text into subword tokens, mapping each token to a numerical identifier according to a predefined vocabulary. This produces an ordered sequence of integers representing the prompt. The server may also add special tokens such as start-of-sequence and end-of-sequence markers. The output of this step is a tokenized prompt sequence and associated model configuration parameters (for example, maximum output length and temperature) packaged into a model input structure.

### Step 7

The server submits the tokenized prompt sequence to the generative AI model and obtains raw output token probabilities. The input of this step is the model input structure produced in Step 6. The server passes the sequence and configuration parameters to a generative AI model implemented as a transformer-based neural network, either locally or via a model-serving interface. Internally, the model computes embeddings of the input tokens, applies multi-head self-attention and feed-forward layers, and produces a sequence of output logits representing unnormalized probabilities over the vocabulary for each generation step. The server or model then applies a sampling or decoding algorithm such as greedy decoding, top-k sampling, or nucleus sampling (top-p) to convert logits into output token indices step by step. The output of this step is a generated sequence of token identifiers representing the model's response.

### Step 8

The server converts the generated token sequence into a text response and performs post-processing. The input of this step is the sequence of token identifiers obtained in Step 7. The server uses the same vocabulary mapping to turn each token identifier into a text fragment and concatenates the fragments into a response string. The server then applies post-processing operations such as removing trailing incomplete sentences, normalizing spacing and punctuation, and optionally filtering forbidden terms according to a content policy. The server may also segment the text into paragraphs or bullet points based on newline characters or punctuation. The output of this step is a clean response text suitable for display to the user.

### Step 9

The server stores interaction data and constructs a response message. The input of this step is the user request record from Step 4, the extended prompt sentence from Step 5, and the response text from Step 8. The server creates a response record that includes a generated content identifier, the original prompt sentence, the extended prompt sentence, model configuration parameters, and the response text. The server writes this record to a persistent storage system such as a database. The server then constructs a response message for the terminal, embedding the response text and the content identifier, and encodes the message as a structured text object. The output of this step is a network-ready response message with the generated content and metadata.

### Step 10

The server sends the response message to the terminal. The input of this step is the response message from Step 9. The server uses its network interface to transmit the message over the communication network as an HTTP response or equivalent protocol response. The server ensures that the response status code indicates success and may include additional headers describing processing time or model version. The output of this step is a network packet sequence carrying the generated response back to the terminal.

### Step 11

The terminal receives and displays the generated response to the user. The input of this step is the incoming response packet sequence from the server. The terminal's network stack reconstructs the response message and provides it to the application. The terminal parses the structured content, extracts the response text and content identifier, and updates internal state variables. The terminal hides the loading indicator and renders the response text in a display element such as a scrollable text area. The output of this step is a visual presentation of the generated response on the terminal screen, accessible to the user.

### Step 12

The user evaluates the displayed response. The input of this step is the visual output produced in Step 11. The user reads the response and decides whether the content is relevant, accurate, and helpful. The user then interacts with a feedback control on the terminal, such as selecting “helpful” or “not helpful,” or selecting a numeric rating. The terminal converts the user's interaction into a structured evaluation value, for example a rating between 1 and 5, and associates this with the content identifier, the original prompt sentence, and a timestamp. The output of this step is an evaluation object stored temporarily in the terminal.

### Step 13

The terminal sends user evaluation data to the server. The input of this step is the evaluation object from Step 12. The terminal creates a feedback payload containing the evaluation value, the content identifier, the user identifier (if available), the original prompt sentence, and the timestamp. The terminal encodes this payload as a structured message and transmits it to a feedback endpoint on the server using a secure communication protocol. The output of this step is a feedback request message delivered from the terminal to the server.

### Step 14

The server receives, parses, and stores the user evaluation data. The input of this step is the feedback request message from Step 13. The server's web framework routes the request to a feedback handler, which parses the payload and extracts the evaluation value, content identifier, and associated metadata. The server then creates a feedback record and writes it into a database table or collection that links feedback records with corresponding response records via the content identifier. The server may also update aggregated statistics such as average rating per topic in memory. The output of this step is a persistent association between the user's evaluation, the prompt sentence, and the response text in the server's data store.

### Step 15

The server builds and updates a training data set based on response history and evaluations. The input of this step is a collection of stored response records and feedback records accumulated over time. The server executes a batch or periodic job that queries the database for interactions with recorded evaluation values. The server processes each record to create training samples that include the extended prompt sentence, the response text, and a label derived from the evaluation (for example, positive or negative). The server stores these samples in a structured training data set file or table, such as a list of prompt-response-label tuples. The output of this step is an updated training data set ready for use in adjusting the generative AI model or prompt construction rules.

### Step 16

The server performs a model adjustment or fine-tuning process using the training data set. The input of this step is the training data set produced in Step 15 and the current parameters of the generative AI model. The server, or an external training apparatus controlled by the server, initializes a training loop that reads batches of training samples. For each batch, the model computes predicted token sequences or probabilities for the responses given the prompt sentences, and the training process computes a loss function that reflects the difference between preferred and non-preferred outputs, such as cross-entropy loss weighted by evaluation labels or a ranking loss between positive and negative examples. The training algorithm computes gradients of the loss with respect to model parameters and updates the parameters using an optimization method such as stochastic gradient descent or Adam. The output of this step is an updated set of model parameters representing an adjusted or fine-tuned generative AI model.

### Step 17

The server updates prompt construction rules and deploys the adjusted behavior for future requests. The input of this step is the updated model parameters from Step 16 and analytics derived from the training data set, such as which prompt patterns yield high evaluation scores.

The server may modify a configuration file or rule table that governs how extended prompt sentences are formed, for example by including emotional tags, specifying output length constraints, or changing the ordering of context blocks. The server also deploys the updated generative AI model to an inference environment or updates internal references to point to a new model endpoint. The output of this step is a new operational configuration in which subsequent user requests processed in Steps 4 through 11 will use an improved generative AI model and refined prompt construction logic informed by the collected user evaluations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize a generative AI model typically accept free-form user input and generate responses based on static prompts or manually engineered instructions. Such systems suffer from several technical limitations in terms of computer technology. First, when a user wishes to impose custom responses for specific inquiries, the user is often required to manipulate model parameters indirectly or edit complex prompt templates, which leads to inefficient use of processing resources and inconsistent behavior of the model. The absence of a structured mechanism for converting end-user configuration operations into machine-processable prompt sentences results in repeated manual prompt design and an increased number of network roundtrips and model calls, thereby degrading throughput and latency of the overall system.

Second, existing systems generally do not provide an integrated pipeline that transforms user-defined inquiry-response pairs into a reusable instruction set for the generative AI model, nor do they manage these instructions as first-class data objects for matching against incoming dialog queries. As a result, the generative AI model cannot reliably reproduce custom behavior in a consistent and predictable manner, forcing repeated computation and redundant inference paths, which inefficiently consumes processor cycles, memory bandwidth, and network resources.

Third, even when custom responses are supported, conventional architectures seldom leverage semantic similarity computation or vectorized representations of inquiries to efficiently select relevant response patterns at runtime. In the absence of such mechanisms, the system often resorts to simple string matching or hard-coded rules, which scale poorly as the number of patterns grows and which increase lookup time, cache misses, and database access overhead. This leads to performance bottlenecks and degraded responsiveness that are undesirable in interactive applications.

Fourth, typical systems do not tightly couple user emotional state analysis or user interest analysis with the prompt generation pipeline for the generative AI model. Emotional information and interest information, if used at all, are handled in separate modules and not propagated as structured constraints into the prompt sentences. This separation prevents the system from exploiting the full expressive capabilities of machine learning models for personalization, and it leads to fragmented state management, duplicated computation, and sub-optimal use of memory and storage structures.

Accordingly, there is a need for a computer-implemented technique that improves the functioning of dialog systems using a generative AI model by: (i) programmatically converting user-configured inquiry-response pairs into structured prompt sentences that can be processed by the generative AI model; (ii) efficiently storing, indexing, and retrieving these patterns using semantic vector representations; and (iii) dynamically constructing composite prompt sentences at inference time to enforce user-defined behavior, emotional adaptation, and interest-based information provision, thereby improving overall system performance, determinism of responses, and resource utilization in the underlying computer infrastructure.

The specific processing by the specific processing unit 290 of the data processing device 12 in Example 2 is realized by the following means.

The present invention provides a server comprising a processor and a memory storing instructions which, when executed by the processor, cause the server to receive, via a user input/output interface operating on a terminal device, configuration operations for dialog processing using a generative AI model; to obtain, from the terminal device, pairs of user-defined inquiries and corresponding response contents and register the pairs as response patterns; to normalize inquiry strings and embed response contents into template-based prompt sentences in which each prompt sentence explicitly instructs the generative AI model how to respond when a corresponding inquiry is made; to automatically generate and collectively supply a plurality of such prompt sentences to the generative AI model so that the generative AI model is conditioned or trained to conform to the user-defined response patterns; to generate feature vectors representing the inquiries, store the feature vectors in an index structure, and execute similarity search over the feature vectors to identify, at runtime, a response pattern that is semantically closest to a newly received user inquiry; and to dynamically construct a composite prompt including at least one prompt sentence corresponding to the identified response pattern together with current dialog context, emotional state information, and user interest information, and to transmit the composite prompt to the generative AI model so as to control the generative AI model to generate a response that preferentially reflects the registered custom responses. This enables a computer-implemented dialog system to convert end-user configuration data into machine-optimized prompt sentences, to manage and retrieve response patterns using vectorized semantic indexing, and to dynamically synthesize prompts that enforce user-defined behavior and personalization, thereby improving response consistency, reducing redundant inference operations, and enhancing overall computational efficiency of the generative AI-based dialog processing.

The term “system” refers to a computer-implemented arrangement including at least one processor and one or more memories, communicatively coupled to one or more terminal devices and a generative AI model, and configured to execute dialog processing functions as described herein.

The term “processor” refers to a hardware processing unit, such as a central processing unit or other programmable computation unit, that executes instructions stored in a memory to perform the functions described in the claims.

The term “memory” refers to one or more non-transitory computer-readable storage media, such as semiconductor memory, magnetic storage, or optical storage, that store instructions and data for execution by the processor.

The term “terminal device” refers to an information processing device operated by a user, such as a client computing device equipped with an input/output interface and a communication interface, and capable of sending and receiving data to and from the server.

The term “user input/output interface” refers to a software-implemented and hardware-assisted interface on a terminal device that enables a user to input information and receive output, including graphical user interfaces, web interfaces, command-line interfaces, and associated input/output devices.

The term “generative AI model” refers to a machine learning model configured to generate natural language or other data in response to an input, including but not limited to a large language model that produces text outputs based on prompt sentences.

The term “prompt sentence” refers to an instruction text, or a set of instruction texts, provided to the generative AI model to control or condition the behavior of the generative AI model when generating responses.

The term “dialog processing” refers to computer-implemented processing that manages interactive exchanges of information between a user and a system, including receiving user messages, generating system responses, and maintaining dialog context.

The term “chatbot function” refers to a software-implemented functionality that provides interactive responses to user inputs, using the generative AI model and associated logic to generate and deliver dialog outputs.

The term “request” refers to information input by a user via the terminal device, including text queries, commands, or other inputs that seek a response or action from the system.

The term “response” refers to information generated by the generative AI model or the system and provided to the user in reply to a user request, typically in the form of natural language text.

The term “test input data” refers to one or more data items prepared for evaluation of the chatbot function, including predefined input messages, used to assess the appropriateness or quality of generated responses.

The term “learning data set” refers to a collection of data used to condition, fine-tune, or otherwise adjust the behavior of the generative AI model, including training data, instruction data, and correction data.

The term “evaluation result” refers to data representing an outcome of analysis of responses generated by the chatbot function, including scores, labels, or metrics that quantify response quality or suitability.

The term “user input text data” refers to textual information entered by the user via the terminal device, including chat messages, typed queries, and other character-based inputs.

The term “audio data” refers to digitized representations of sound captured from the user, including spoken utterances, recorded voice, or other acoustic signals.

The term “image data” refers to still or moving visual data representing the user or the user's environment, including camera images and video frames.

The term “emotional state” refers to an estimated or inferred affective condition of the user, such as happiness, sadness, anger, or other emotional categories, detected based on user input data.

The term “response pattern” refers to a structured association between a specific inquiry and corresponding response content, registered by the user for use as a custom behavior in the dialog system.

The term “custom response” refers to a response content specified or configured by the user for a particular inquiry, stored as part of a response pattern and intended to override or guide the generative AI model's default behavior.

The term “inquiry” refers to a user-provided question, request, or utterance that is intended to elicit a response from the system.

The term “response content” refers to a predefined or generated text or other data that constitutes the answer or reply associated with an inquiry.

The term “data storage device” refers to a storage component or subsystem, including databases and file systems, that stores response patterns, prompt sentences, feature vectors, and other data used by the system.

The term “online environment” refers to an execution environment in which the chatbot function is accessible via a communication network, such as a wide-area or local-area network.

The term “local environment” refers to an execution environment in which the chatbot function operates on a computing device without requiring a continuous external network connection, such as a stand-alone deployment.

The term “operation history information” refers to recorded data representing past interactions of users with the chatbot function, including timestamps, input messages, responses, and usage patterns.

The term “interest information” refers to data derived from analysis of operation history information that characterizes preferences, topics, or domains for which a user shows interest.

The term “content data” refers to media or information that a user is currently viewing or watching, including text documents, web pages, videos, or other digital content.

The term “instruction information set” refers to a collection of prompt sentences or related control data that together specify how the generative AI model should respond to certain inputs.

The term “feature vector” refers to a numerical representation of an inquiry or other text, produced by vectorization processing, that captures semantic or syntactic characteristics of the text.

The term “vectorization processing” refers to a computation that converts a text or other data into a feature vector, using a machine learning model or other algorithm for generating numerical embeddings.

The term “similarity search” refers to a search process that identifies items, such as response patterns, whose feature vectors have high similarity to a query vector according to a similarity measure.

The term “similarity measure” refers to a quantitative function, such as cosine similarity or distance metrics, used to compute similarity between feature vectors.

The term “search processing unit” refers to a software-implemented or hardware-assisted component that performs similarity search or other retrieval operations over stored feature vectors or response patterns.

The term “composite prompt” refers to a prompt structure that combines multiple prompt sentences, dialog context, emotional state information, interest information, or other control data into a single input to the generative AI model.

The term “dialog context” refers to information representing preceding exchanges in a conversation, including prior user inputs and system responses, used to condition subsequent responses.

In one embodiment, a server cooperates with one or more terminals and a generative AI model to implement the dialog system described in the claims. The server includes at least one processor, such as a multi-core central processing unit, one or more hardware accelerators such as graphics processing units, a main memory, and one or more non-transitory storage devices such as solid-state drives. The server executes an operating system such as a general-purpose server operating system and runs application software including a web server component (for example, a generic HTTP server), an application framework (for example, a generic scripting-language framework), database management software, and libraries for communication with a generative AI model. The server is connected through a communication network to the terminals and, if the generative AI model is hosted remotely, to a model-providing service.

In one embodiment, the terminal is a general-purpose information processing device such as a smartphone, tablet, or personal computer. The terminal includes a processor, memory, a display, and input devices such as a keyboard, touch panel, or microphone. The terminal executes a web browser or a native application providing a user input/output interface. The user operates the terminal to configure inquiry-response patterns, to interact with the chatbot, and to confirm generated responses.

In one embodiment, the user operates the terminal to access a configuration interface hosted by the server. The terminal sends a request via Hypertext Transfer Protocol over Transport Layer Security to the server. The server responds by transmitting markup language documents, style definitions, and script code. The terminal executes the script code in the browser engine, constructs a document object model, and renders input fields for user-defined inquiries and responses. The user enters a specific inquiry such as “Tell me today's weather forecast.” and an associated response content such as “Today's weather is sunny.” into the input fields. The terminal temporarily stores these strings in main memory as character sequences, performs client-side validation, and then transmits the data to the server as a structured payload.

In one embodiment, the server receives the user-defined inquiry and response from the terminal, parses the structured payload, and stores the data in a relational or document-oriented database. The server normalizes the inquiry text by applying string processing operations such as trimming whitespace, converting character encodings to a unified format, and optionally lowercasing or normalizing punctuation. The server also normalizes the response text. The server writes a record for each response pattern, including at least a user identifier, a normalized inquiry string, a normalized response string, timestamps, and a pattern identifier.

In one embodiment, the server generates a prompt sentence for each stored response pattern using a deterministic template mechanism. The server maintains one or more text templates in memory, for example:
“When the user asks ‘{QUESTION}’, please answer ‘{ANSWER}’.”

The server replaces the placeholder “{QUESTION}” with the normalized inquiry and replaces the placeholder “{ANSWER}” with the normalized response content. As a result, for the above example, the server generates a prompt sentence:
“When the user asks ‘Tell me today's weather forecast.’, please answer ‘Today's weather is sunny.’.”

The server may generate other prompt sentences for different patterns, for example:
“When the user asks ‘What are your business hours?’, please answer ‘Our business hours are from 9 AM to 5 PM on weekdays.’.”
“When the user asks ‘How can I reset my password?’, please answer ‘You can reset your password by clicking ‘Forgot password’ on the login page.’.”

In one embodiment, the server aggregates a plurality of such prompt sentences associated with one user or one chatbot instance. The server constructs a set of instruction text that defines the desired behavior of the generative AI model for a collection of specific inquiries. The server then transmits this set of instruction text to the generative AI model through an application programming interface. The server may treat these prompt sentences as system-level or instruction-level messages in a message-based interface of the generative AI model. The generative AI model may be an autoregressive transformer-based neural network with multiple self-attention layers, token embedding layers, position encoding, and output projection layers, trained on large text corpora by minimizing a sequence prediction loss such as cross-entropy.

In one embodiment, the server uses the generative AI model in a conditioning or fine-tuning configuration. In a conditioning configuration, the server repeatedly supplies the template-based prompt sentences as context so that the internal hidden states of the transformer network encode the mapping between the specific inquiries and response contents. In a fine-tuning configuration, the server supplies training examples consisting of an input instruction and an expected output, and the model-providing system adjusts internal parameters by gradient-based optimization. In either configuration, the server relies on an explicit mapping from user-defined patterns to prompt sentences so that the generative AI model behavior is constrained by data structures that are directly derived from user configuration.

In one embodiment, the server constructs numerical feature vectors representing the normalized inquiries. The server uses a vectorization model, such as a neural embedding model comprising an embedding layer, one or more transformer or recurrent layers, and a pooling operation to derive a fixed-length vector for each inquiry. The server computes these feature vectors offline or at registration time and stores them in a database along with the corresponding response pattern identifiers. The feature vectors may be stored in a table that supports vector operations or in a specialized vector index such as an approximate nearest-neighbor index. By precomputing and storing these feature vectors, the server avoids recomputing embeddings for every lookup, thereby reducing processor load and improving latency.

In one embodiment, the server performs similarity search using a similarity measure such as cosine similarity or Euclidean distance between feature vectors. When the user later submits a new inquiry during dialog, the server normalizes the new inquiry string and computes a feature vector for the new inquiry using the same vectorization model. The server then searches the stored vectors for those with highest similarity to the new vector. By using a vector index and approximate nearest-neighbor algorithms, the server reduces the number of distance computations required and minimizes memory access overhead. The server selects one or more response patterns whose inquiry vectors are closest to the vector of the new inquiry.

In one embodiment, the server dynamically constructs a composite prompt for the generative AI model based on the selected response patterns and the current dialog context. The server collects prompt sentences corresponding to the selected response patterns, and combines them with other control text such as a system instruction and the latest user message. For example, when the user sends the inquiry “Tell me today's weather forecast.”, the server may build a composite prompt including:
“You are a chatbot that must strictly follow user-defined response patterns when they match the user's question.”
“When the user asks ‘Tell me today's weather forecast.’, please answer ‘Today's weather is sunny.’.”
“Tell me today's weather forecast.”

The server then transmits this composite prompt to the generative AI model. Because the composite prompt explicitly encodes the mapping between the user's inquiry and the desired response, and because similar inquiries are identified via feature vectors, the generative AI model can produce a response that is consistent with user configuration without relying on ad-hoc manual prompt engineering for each dialog session.

In one embodiment, the server acquires additional user data such as text messages, audio signals, or image frames to estimate an emotional state of the user. The server may apply a separate machine learning model to classify emotional categories based on prosodic features of audio, facial features extracted from images, or lexical features of text. For instance, the server may extract mel-frequency cepstral coefficients from audio frames or facial landmark vectors from image frames, and feed them into a convolutional or recurrent neural network trained to output emotion labels and confidence scores. The server then embeds the detected emotional state into the composite prompt as additional control text, such as:
“The user currently appears to be frustrated. When answering, use a calm and empathetic tone.”

By integrating emotional information into the prompt sentences, the server instructs the generative AI model to adjust tone and style of responses, thereby improving perceived quality while maintaining the explicit control of content through the response patterns. In one embodiment, the server analyzes operation history information of multiple users. The server stores logs including timestamps, user identifiers, message contents, selected response patterns, and model outputs. The server executes data processing to detect frequent topics or domains of interest for each user, using methods such as keyword extraction or topic modeling. The server summarizes interest information per user and stores it in a user profile structure. When constructing composite prompts, the server may include statements such as:
“The user is generally interested in travel information and local events.”
or
“The user often asks about customer support procedures.”

These statements allow the generative AI model to prioritize or contextualize information in generated responses. In this manner, the system uses technical data structures (logs, profiles, indices) and algorithms (vectorization, similarity search, classification, topic modeling) to enhance personalization.

In one embodiment, the server exposes the chatbot function to other users through a network interface or deploys the chatbot in a local environment. The server handles multiple concurrent sessions, manages connection pooling, and utilizes caching mechanisms for commonly used prompt sentences and feature vectors. For example, the server may maintain in main memory a cache of frequently accessed response patterns and their associated feature vectors, thereby reducing disk access and improving throughput. The server can also batch multiple generative AI model calls by aggregating prompts for different users, which reduces the number of network connections to the model-providing service and lowers communication load.

This architecture provides improvements in computer technology that go beyond mere automation of human mental steps or generic use of a computer. By transforming user-defined inquiry-response pairs into structured prompt sentences using a defined template mechanism, by precomputing and indexing semantic feature vectors for efficient similarity search, and by dynamically constructing composite prompts that combine pattern-specific instructions, dialog context, emotional state, and user interest information, the server improves the determinism and stability of model behavior while reducing redundant computation. The use of vector indices and approximate nearest-neighbor search lowers the time complexity of response pattern retrieval compared to naive string matching, directly reducing processor cycles and memory bandwidth usage. The aggregation and reuse of prompt sentences for conditioning or fine-tuning reduce the number of large model calls required to achieve consistent customized behavior, thereby lowering network latency and improving system-level throughput.

Furthermore, the explicit template-based generation of prompt sentences and the explicit mapping from feature vectors to response patterns provide a technical control layer around the generative AI model, such that the system can enforce specific mappings even when the underlying model is probabilistic. The server does not simply “let the model decide,” but constrains and directs the model via structured, machine-generated instructions derived from user configuration and computed similarity. This non-conventional combination of template generation, semantic indexing, and prompt composition modifies how the computer allocates memory for instructions, how it schedules and batches model calls, and how it retrieves data from storage, thereby improving computational efficiency and reducing error rates in response selection.

In another embodiment, the server may use alternative models for vectorization, such as convolutional neural networks, or may use different distance metrics such as inner product similarity. The server may also use hierarchical indices or clustering structures to organize response patterns by domain or topic. In another variation, the server may maintain multiple sets of prompt templates, for example, a set for strict verbatim responses and another set for paraphrased or extended responses, and select among them based on metadata in the response pattern or based on user-specified preferences. In another embodiment, the server may perform incremental updating of feature vectors and indices when the user edits or deletes response patterns, thereby maintaining index consistency without complete recomputation. In yet another embodiment, the generative AI model may be deployed on the server itself using local hardware accelerators. In such a case, the server loads the model parameters into high-bandwidth memory on a graphics processing unit and executes inference by applying matrix multiplication kernels with optimized low-precision arithmetic. The server can adjust model parameters by fine-tuning with user-specific training data that include the template-based prompt sentences and desired outputs, using gradient descent, backpropagation through time, and mini-batch optimization. The server may use regularization techniques, learning rate schedules, and early stopping criteria to maintain generalization performance. By integrating the template-based instruction mechanism and similarity-based pattern selection into the training loop, the server can achieve a more compact and efficient model specialized for a particular domain or user group, reducing inference time and memory footprint.

Thus, across these embodiments, the server, the terminal, and the generative AI model cooperate via defined data structures, algorithms, and communication patterns to implement a dialog system in which user-defined response patterns are transformed into machine-optimized prompt sentences and are exploited through semantic retrieval and composite prompt construction. This configuration yields technical effects such as faster response pattern matching, reduced communication load with the model-providing service, improved consistency and predictability of responses, and more efficient utilization of processing and storage resources, thereby improving the functioning of the computer system itself.

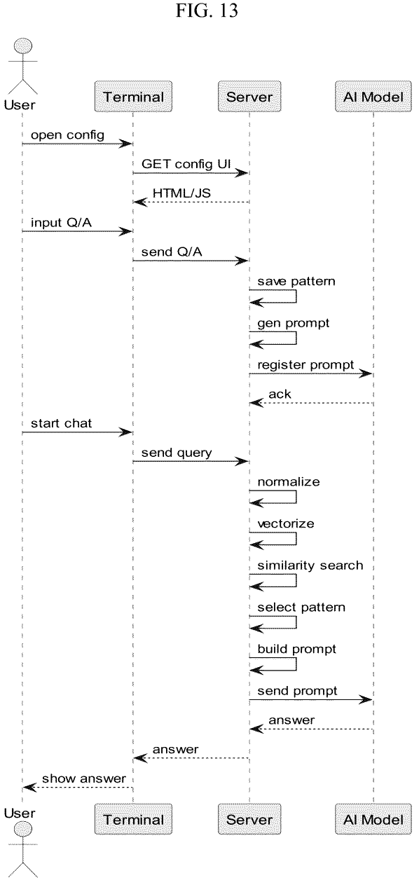

The following describes the processing flow using FIG. 13.

### Step 1

The user operates the terminal to open a configuration interface for the dialog system.

The terminal sends a request to the server to obtain a configuration page.
Input: A page request generated by the terminal.
Output: A configuration screen with input fields for an inquiry and a response, displayed on the terminal.

The server receives the request, reads markup, style, and script files from storage, and sends them to the terminal.

The terminal executes the received script, builds a document object model, and renders text input fields and a save button on the display.

### Step 2

The user enters a custom inquiry and a corresponding response on the terminal.

The terminal captures the user's keystrokes and stores the inquiry and response as string data in memory.
Input: Keystrokes and pointer events from the user.
Output: A pair of text strings representing the inquiry and the response, held in terminal memory.

The terminal performs client-side validation, such as checking that both fields are non-empty and within a maximum length, and updates the user interface to enable the save button when validation succeeds.

### Step 3

The user instructs the terminal to save the response pattern.

The terminal packages the inquiry and response into a structured payload and sends it to the server over a network.
Input: The inquiry string and the response string stored in terminal memory.
Output: A structured data message, transmitted to the server, containing the inquiry and response as fields.

The terminal serializes the strings into a data structure, attaches metadata such as a user identifier and a timestamp, and transmits the data using a network protocol.

### Step 4

The server receives the response pattern data from the terminal.

The server parses the structured payload to extract the inquiry and response strings.
Input: The structured data message received from the terminal.
Output: Normalized inquiry and response strings ready for storage and further processing.

The server verifies that the payload conforms to an expected format and checks for missing or invalid fields before proceeding.

### Step 5

The server normalizes the inquiry and response text.

The server applies string operations such as whitespace trimming, character encoding unification, and punctuation normalization.
Input: Raw inquiry and response strings extracted from the payload.
Output: Normalized inquiry and response strings stored in server memory.

The server may convert full-width characters to half-width characters, remove unsupported control characters, and standardize line breaks to reduce variability during later comparison and embedding.

### Step 6

The server stores the normalized response pattern in a data storage device.

The server creates a record that links the user, the inquiry, and the response, and persists this record in a database table or document collection.
Input: Normalized inquiry and response strings, along with a user identifier and timestamps.
Output: A stored response pattern record identified by a pattern identifier.

The server executes a write operation through a database driver, allocates storage for the record, and returns or logs the pattern identifier for subsequent operations.

### Step 7

The server generates a prompt sentence from the stored response pattern.

The server selects a predefined template and inserts the normalized inquiry and response into placeholder positions.
Input: The normalized inquiry and response strings associated with a pattern identifier.
Output: A prompt sentence in natural language instructing the generative AI model how to respond to the inquiry.

The server uses string concatenation and placeholder replacement to produce sentences such as:
“When the user asks ‘Tell me today's weather forecast.’, please answer ‘Today's weather is sunny.’.”

### Step 8

The server registers the prompt sentence with the generative AI model.

The server sends the prompt sentence, together with optional surrounding instructions, to the generative AI model through a model interface.
Input: One or more prompt sentences derived from response patterns.
Output: An acknowledgement or result indicating that the generative AI model has accepted the instructions or training data.

The server formats the prompt sentence as model input, transmits it using a communication library, and waits for a response status, which it stores or logs for tracking.

### Step 9

The server generates a feature vector for the inquiry associated with the response pattern.

The server applies a vectorization model to convert the normalized inquiry string into a numeric vector.
Input: The normalized inquiry string.
Output: A feature vector representing the semantic characteristics of the inquiry.

The server tokenizes the text, maps tokens to embeddings, processes them through neural network layers such as transformer blocks, and applies a pooling operation to obtain a fixed-length vector.

### Step 10

The server stores the feature vector and links it to the response pattern.

The server writes the feature vector, the pattern identifier, and any additional metadata into a vector index or database.
Input: The feature vector and the pattern identifier.
Output: An indexed entry that enables similarity search based on the feature vector.

The server may quantize or compress the vector for efficient storage, update an index structure such as an approximate nearest-neighbor index, and record index statistics.

### Step 11

The user starts a dialog with the chatbot using the terminal.

The terminal captures a new inquiry from the user through the chat interface and sends it to the server.
Input: A new user inquiry string entered in the chat window.
Output: A structured message containing the new inquiry, sent to the server for processing.

The terminal may attach session information and user identifiers to the message so that the server can associate the inquiry with the correct set of response patterns.

### Step 12

The server receives the new inquiry and prepares it for matching.

The server parses the incoming message, extracts the inquiry string, and normalizes it using the same rules as for stored patterns.
Input: The structured message containing the new user inquiry.
Output: A normalized inquiry string suitable for vectorization and comparison.

The server may also retrieve related dialog context from storage or memory to incorporate into subsequent prompt construction.

### Step 13

The server computes a feature vector for the new inquiry.

The server applies the same vectorization model that was used for stored inquiries to the normalized new inquiry string.
Input: The normalized new inquiry string.
Output: A feature vector representing the semantic content of the new inquiry.

The server processes the text through tokenization and neural network layers, then produces a fixed-length numerical array and holds it in memory for similarity calculation.

### Step 14

The server performs similarity search between the new feature vector and stored feature vectors.

The server queries the vector index to find one or more stored response patterns whose vectors are closest to the new vector according to a similarity measure.
Input: The feature vector of the new inquiry and the vector index containing stored feature vectors.
Output: One or more candidate response patterns ranked by similarity.

The server calculates similarity scores, prunes low-scoring candidates, and selects the highest scoring pattern or a small set of top patterns for further processing.

### Step 15

The server selects an appropriate response pattern for the new inquiry.

The server evaluates the candidate patterns returned by the similarity search and chooses the pattern that best matches the new inquiry based on similarity thresholds and optional rules.
Input: A ranked list of candidate response patterns with similarity scores.
Output: A selected response pattern with its associated inquiry, response content, and prompt sentence.

The server may apply additional filters, such as user-specific constraints or domain restrictions, before final selection.

### Step 16

The server constructs a composite prompt for the generative AI model.

The server combines a system-level instruction, the prompt sentence corresponding to the selected response pattern, and the current user inquiry into a structured set of instructions.
Input: The selected response pattern, its prompt sentence, and the normalized new inquiry, optionally along with dialog context and user state information.
Output: A composite prompt that encodes both user-defined behavior and current dialog content.

The server concatenates text segments, orders them according to a predetermined format, and prepares a single instruction sequence to control the generative AI model.

### Step 17

The server sends the composite prompt to the generative AI model and obtains a generated response.

The server transmits the composite prompt to the model, waits for inference to complete, and receives a generated output string.
Input: The composite prompt constructed from response patterns and current inquiry.
Output: A generated response text produced by the generative AI model.

The server receives the model output, extracts the relevant text field, and may perform post-processing such as trimming or sanitation before further use.

### Step 18

The server returns the generated response to the terminal.

The server packages the response text in a structured format and sends it back to the terminal over the network.
Input: The generated response text obtained from the generative AI model.
Output: A response message containing the answer to be displayed to the user.

The server may log the interaction for future analysis and update operation history records associated with the user.

### Step 19

The terminal displays the generated response to the user.

The terminal parses the response message and renders the answer in the chat interface as a new message bubble.
Input: The response message received from the server.
Output: A visual representation of the chatbot's response on the terminal display.

The terminal updates the chat window, scrolls to the latest message if needed, and waits for further user input.

### Step 20

The server optionally updates model-related data based on dialog performance.

The server analyzes generated responses and user behavior, such as corrections or follow-up messages, and may record evaluation signals to improve future processing.
Input: Logs of inquiries, selected patterns, generated responses, and user interactions during the dialog.
Output: Updated statistics, quality indicators, or training examples that can be used to refine response patterns or model behavior.

The server may adjust similarity thresholds, modify or add response patterns, or prepare additional prompt sentences for subsequent conditioning or fine-tuning of the generative AI model.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that utilize a generative AI model generally accept user input and pass it to the generative AI model with a simple, static prompt. Such systems treat prompt construction as a fixed template and do not systematically integrate user-defined dialogue patterns, multi-modal emotion analysis, viewing context, or long-term usage tendencies into the prompt generation and learning process. As a result, these systems often exhibit several technical deficiencies in terms of computer technology.

First, the processor in such systems does not maintain a structured representation of user-defined question-answer pairs or dialogue rules, and therefore cannot reliably bias the generative AI model toward enterprise-specific policies or customized responses. Because the prompt does not embed explicit dialogue pattern information or custom responses, the generative AI model tends to generate inconsistent or policy-violating outputs, which forces the system to perform additional post-processing or manual correction. This leads to inefficient use of computational resources and degrades the reliability of the dialog engine.

Second, conventional systems typically handle user emotion or interest, if at all, as an auxiliary signal that is not tightly coupled to prompt construction. Even when a sentiment classifier is present, its output is not encoded into a formal prompt representation that can be repeatedly leveraged across sessions. The absence of a unified mechanism for acquiring and fusing text data, audio data, image data, and behavior log data into a single context object prevents the processor from generating prompt sentences that are optimally adapted to a user's emotional state and interest state. As a consequence, the generative AI model cannot systematically adjust its responses based on rich, multi-modal context, which limits the robustness and personalization of the system.

Third, typical systems do not exploit structured information about audiovisual content currently being consumed by the user. While the device may know which content is playing, the server often does not identify such content or retrieve associated metadata in a way that can be embedded into the prompt. Without content identification information and related metadata being incorporated into a prompt sentence, the generative AI model cannot efficiently generate targeted explanatory information. This causes unnecessary additional queries, redundant external lookups, and increased latency, thereby reducing overall system efficiency from a computer-technical point of view.

Fourth, in existing architectures, evaluation of generated responses and subsequent learning are usually manual or loosely coupled. The processor may log conversations, but it does not systematically analyze responses using a language analysis model or evaluation rules to update prompt generation rules and learning data in a closed loop. There is no mechanism to automatically identify intent categories or emotion categories with frequent misjudgment and selectively modify corresponding prompt templates or learning data. This absence of a feedback-driven optimization pipeline leads to stagnation of model performance and inefficient utilization of storage and computation for learning data management.

Fifth, conventional systems provide limited support for managing and publishing interactive response programs to multiple users while leveraging the resulting usage data as a technical signal. When a chat-like program is shared with other users, the system rarely analyzes aggregated operation histories to extract usage tendencies and interest tendencies and then automatically adjusts prompts and learning data. As a result, the server does not transform user operation logs into a structured resource that can be used to reconfigure system behavior at scale. This causes suboptimal allocation of computing resources and prevents global improvements across deployments.

Therefore, there is a need for a technical mechanism in which a processor: (i) dynamically constructs prompt sentences that explicitly encode user-defined dialogue patterns, custom responses, multi-modal emotion and interest states, and viewing context; (ii) evaluates and optimizes responses from a generative AI model using dialogue rules, operational rules, and external information sources; and (iii) records and exploits dialogue history and feedback from multiple users to update prompt generation rules and learning data in a closed-loop manner. By addressing these issues at the level of data structures, control flow, and model interfacing, the present invention seeks to improve the technical functioning of computer-implemented dialog systems, including stability, response accuracy, latency, and adaptability, rather than merely providing an abstract conversational scheme.

The specific processing by the specific processing unit 290 of the data processing device 12 in Application Example 2 is realized by the following means.

The present invention provides a server comprising a processor configured to receive, via an application or a web interface operating on an information processing apparatus, user operations and user requests for using a generative AI model, to analyze each user request to determine an intent and a context, and to generate a prompt sentence that specifies instructions to the generative AI model; to embed, into the generated prompt sentence, dialogue pattern information including correspondences between user-defined questions and user-defined answers and dialogue history information, thereby constructing the prompt sentence so as to cause the generative AI model to generate a specific response based on the embedded dialogue pattern information; to acquire at least part of text data, audio data, image data, and behavior log data from the information processing apparatus and to analyze the acquired data by using a machine learning model in order to estimate an emotional state and an interest state of the user, and to add the estimated emotional state and the interest state to the prompt sentence in combination with the user request and the dialogue history so as to generate a prompt sentence that causes the generative AI model to generate a response adapted to the emotional state and the interest state; to identify audiovisual content being viewed or listened to by acquiring content identification information, to obtain related metadata based on the content identification information, and to generate a prompt sentence including the related metadata so as to instruct the generative AI model to generate explanatory information relating to the identified content; to evaluate appropriateness and consistency of a response obtained from the generative AI model based on dialogue rules, operational rules, and external information sources, and, when necessary, to generate an additional prompt sentence that instructs the generative AI model to correct or regenerate the response so as to optimize the response; to record, as dialogue history information, the response output by the generative AI model, the prompt sentence used to generate the response, the emotional state, the interest state, and an evaluation result of the response, and to update generation rules for the prompt sentence and learning data for the generative AI model based on the recorded dialogue history information and feedback information from users so as to continuously improve performance of subsequent response generation; and to publish, in an online environment or a local environment, an interactive response program created based on instructions to the generative AI model so that other users can use the interactive response program, to analyze operation histories of a plurality of users who use the published interactive response program to extract a usage tendency and an interest tendency, to automatically adjust the prompt sentence and the learning data based on an extraction result, and to present, via the application or the web interface, the dialogue pattern information, custom responses, and response content adapted to the emotional state and the interest state to users and receive correction input from the users in order to update the dialogue pattern information and the learning data. This enables the server to implement a technically improved dialog engine that dynamically generates and optimizes prompt sentences based on structured multi-modal context, automatically evaluates and refines responses from the generative AI model, and continuously adapts prompt generation rules and learning data using aggregated dialogue histories and user feedback, thereby enhancing accuracy, consistency, efficiency, and scalability of computer-implemented conversational processing.

The term “information processing apparatus” refers to an electronic device that executes software to perform data input, data processing, and data output, and includes, for example, a portable terminal, a stationary terminal, or a general-purpose computing device equipped with a user interface.

The term “application” refers to a software program that runs on the information processing apparatus and provides a graphical or textual user interface through which a user can perform operations related to a dialog function or access a generative AI model.

The term “web interface” refers to a user interface implemented using web technologies and provided through a network browser or equivalent software, enabling the user to send requests and receive responses related to dialog processing.

The term “generative AI model” refers to a machine learning model that generates natural language text or other structured output in response to an input prompt sentence, based on parameters trained from large-scale training data.

The term “prompt sentence” refers to a text sequence or structured instruction that is supplied to the generative AI model and that defines, constrains, or guides the content, style, or behavior of the response generated by the generative AI model.

The term “dialogue pattern information” refers to structured information representing one or more pairings of input expressions and output expressions, such as correspondences between user-defined questions and user-defined answers, as well as associated conditions or intents that guide dialog behavior.

The term “dialogue history information” refers to stored data representing a sequence of exchanges between a user and a system, including past user inputs, past system responses, associated timestamps, and contextual metadata.

The term “custom response” refers to a response content specified or edited by a user for a particular inquiry, intent, or situation, which is used to bias or override responses generated by the generative AI model.

The term “text data” refers to character-based information obtained from user input or system output, including natural language utterances, commands, or metadata represented as strings.

The term “audio data” refers to digital representations of sound signals, including recorded speech from a user, that can be processed by a speech analysis or speech recognition component.

The term “image data” refers to digital data representing one or more still images or video frames capturing a user, an environment, or content, and that can be processed to extract features such as facial expressions.

The term “behavior log data” refers to recorded information about user operations and interaction patterns within an application or web interface, including click events, typing speed, navigation sequences, and dwell times.

The term “machine learning model” refers to a computational model that is trained on example data to perform classification, regression, detection, or similar tasks, and that can infer features such as intent, emotional state, or interest state from input data.

The term “emotional state” refers to an estimated affective condition of a user, such as joy, sadness, fatigue, anger, or surprise, inferred from at least one of text data, audio data, image data, or behavior log data.

The term “interest state” refers to an estimated preference, focus, or topic-level inclination of a user at a given time, inferred from interaction history, content selection, or other behavioral signals.

The term “intent” refers to a semantic category representing the underlying purpose or goal of a user's request, such as asking for information, requesting an operation, or expressing a feeling.

The term “content identification information” refers to data that uniquely or semi-uniquely identifies audiovisual content being consumed by a user, including identifiers, titles, or time positions.

The term “metadata” refers to structured descriptive information about content or interactions, such as title, author, category, production date, or other attributes associated with identified content.

The term “explanatory information” refers to natural language descriptions, summaries, or clarifications generated by the generative AI model that provide additional explanation or background related to content or a user query.

The term “dialogue rules” refers to predefined conditions or constraints that regulate how a dialog system should respond, including allowed response formats, politeness levels, and conversation flow controls.

The term “operational rules” refers to constraints and policies defined by a system operator, such as business rules, service conditions, security requirements, or usage limits that bound the content or timing of generated responses.

The term “external information sources” refers to data repositories or services that are external to the dialog system's main storage, such as third-party databases, web services, or sensor systems, that provide reference information for evaluating or supplementing generated responses.

The term “evaluation result” refers to information representing the outcome of an assessment of a generated response, including scores, labels, or flags indicating appropriateness, correctness, consistency, or quality.

The term “learning data” refers to data used to train or adapt a generative AI model or auxiliary models, including example inputs, target outputs, prompt templates, and feedback-derived annotations.

The term “generation rules for the prompt sentence” refers to procedures, templates, and parameter settings that govern how a prompt sentence is constructed from user requests, dialogue history information, emotional state, interest state, and other context.

The term “interactive response program” refers to a software component or configuration that uses a generative AI model in conjunction with prompt sentences to provide turn-by-turn dialog responses to users via an application or web interface.

The term “online environment” refers to an execution environment in which the interactive response program is accessible over a communication network, allowing remote users to interact with the program.

The term “local environment” refers to an execution environment in which the interactive response program runs on a local device or an isolated network segment without requiring continuous access to an external communication network.

The term “usage tendency” refers to a pattern or statistical characteristic derived from aggregated operation histories of multiple users, indicating how users generally interact with the interactive response program.

The term “interest tendency” refers to a pattern or statistical characteristic derived from aggregated user interactions that reflects common topics, preferences, or information categories frequently requested by users.

The term “feedback information” refers to explicit or implicit signals from users regarding the usefulness, correctness, or appropriateness of responses, including ratings, flags, corrections, or follow-up behavior.

The term “language analysis model” refers to a software component that applies natural language processing techniques to evaluate or score generated text, for example with respect to grammar, semantics, coherence, or policy compliance.

The term “template of the prompt sentence” refers to a predefined structure for a prompt sentence, including placeholders for variable elements such as user text, emotion labels, metadata, or examples, which is instantiated at runtime to form a concrete prompt sentence.

The term “intent category” refers to a classified group of similar user intents used for organizing dialog handling logic, such as a category for weather inquiries, a category for content questions, or a category for emotional expressions.

The term “emotion category” refers to a discrete classification label for emotional state, such as positive, negative, neutral, or more fine-grained classes like joy, sadness, anger, or surprise.

In one embodiment, a server cooperates with at least one terminal to implement the claimed system.

The server comprises a processor, a memory, a network interface, and one or more storage devices.

The terminal comprises a processor, a memory, a user interface including at least a display and one or more input devices, and a communication interface.

The server and the terminal communicate over a communication network, such as a packet-switched network.

The server stores in the memory program modules including a prompt generation module, a dialogue pattern management module, a multi-modal analysis module, a context integration module, a generative AI interface module, a response evaluation and optimization module, a learning data update module, and a logging and analytics module.

The terminal stores in the memory an application or a web interface that interacts with the server by transmitting user inputs and by presenting responses and configuration screens to the user.

The terminal provides a user interface through which the user defines question-answer pairs, custom responses, and configuration parameters.

The terminal presents, for example, text input fields for a “user question” and a “system answer,” selection components for intent categories, and controls for saving or modifying dialogue patterns.

The terminal transmits to the server, via the communication interface, structured data representing dialogue pattern information, including associations between user-defined questions and user-defined answers, together with metadata such as user identifiers, time information, and domain identifiers.

The server stores the dialogue pattern information in a persistent storage device using a structured data schema.

The server represents each dialogue pattern as a record including fields such as a pattern identifier, question text, answer text, intent category, emotion label (if specified), and usage statistics.

The server indexes these records using one or more indices, such as an intent-based index or a keyword index, to allow efficient retrieval when constructing a prompt sentence.

The server uses the dialogue pattern management module to manage create, read, update, and delete operations on this dialogue pattern information.

The terminal acquires user text input, audio input, image data, and behavior log data during interactions.

The terminal captures audio via a microphone and image data via a camera, and monitors user operations such as pointer movements, touch events, key strokes, and dwell times on user interface components.

The terminal pre-processes the captured data, for example by compressing audio, resizing images, and aggregating behavior events into time-stamped entries, and transmits the pre-processed data to the server.

The server uses the multi-modal analysis module to derive an emotional state and an interest state of the user from the received data.

The server converts audio into text using a speech recognition model implemented, for example, as a recurrent neural network or a transformer-based acoustic-language model.

The server applies a text emotion classifier implemented as a neural network, such as a transformer encoder trained on labeled emotion data, to classify each text input into emotion categories such as “joy,” “sadness,” or “anger.”

The server applies an image analysis model, such as a convolutional neural network trained for facial expression recognition, to the image data to infer facial-expression-based emotion probabilities.

The server analyzes behavior log data by applying statistical feature extraction, such as computing averages and variances of typing intervals and navigation patterns, and by feeding these features into a machine learning classifier, for example a gradient boosting model or a small neural network, to infer additional emotional or interest-related signals.

The server fuses the outputs of these models by computing a weighted average of probability distributions or by inputting concatenated feature vectors to a fusion network, thereby estimating an aggregate emotional state and an interest state with corresponding confidence values.

The server uses the context integration module to build a unified context object in memory for each dialog session.

The server includes in this context object the latest user request, a representation of dialogue history information, the estimated emotional state, the estimated interest state, and any content identification information associated with audiovisual content being consumed by the user.

The server represents dialogue history information as a sequence of entries, each entry including the user utterance, the system response, time information, and context attributes such as active intent category and emotion estimates at the time.

The server identifies audiovisual content being viewed or listened to by processing content identification information received from the terminal.

The terminal provides content identifiers such as title strings, content IDs, or playback positions when the user requests information about ongoing content.

The server queries a content metadata storage, which may be a relational database or a document database, using the content identifiers as keys.

The server receives related metadata, such as creator name, production year, genre, and cast information, and attaches this metadata to the context object for use in prompt generation.

The server uses the prompt generation module to construct a prompt sentence for a generative AI model based on the unified context object.

The server selects a prompt template according to the intent category derived from the user request and the system configuration.

The server instantiates the template by inserting dialogue pattern information, such as multiple pairs of user-defined questions and answers, and by inserting the emotional state, interest state, and related metadata.

The server may construct, for example, a prompt sentence of the following form:
“You are an assistant for product returns. Learn and follow the following examples.
User: ‘How can I return a product?’
Assistant: ‘You can return items within 30 days after delivery. Please use the return label.’
The current user wrote: ‘Is it still possible to send back my order?’
The detected emotion is ‘worry’.

Answer the current user in a way that is consistent with the examples and that calms the user's worry.”

The server transmits the constructed prompt sentence to the generative AI model via the generative AI interface module.

The server provides the prompt sentence and model control parameters, such as maximum token length and sampling temperature, to a generative AI model implemented, for example, as a transformer-based language model with multiple self-attention layers.

The server receives from the generative AI model an output token sequence representing a proposed response.

The server uses the response evaluation and optimization module to assess the proposed response.

The server applies a language analysis model to the response to evaluate properties such as grammatical correctness, semantic coherence, and compliance with dialogue rules and operational rules.

The server compares key phrases in the response with business constraints or policy data stored in a system rule base to ensure that the response does not violate operational rules.

The server optionally queries external information sources, such as external data services, to verify factual assertions contained in the response by matching extracted entities and attributes.

The server computes evaluation scores, such as a correctness score and a policy-compliance score, and determines whether the response is acceptable based on threshold conditions. When the response is not acceptable, the server generates an additional prompt sentence that includes an instruction such as “Rewrite the previous answer so that it does not mention a return period longer than 30 days and remains consistent with the reference example,” and re-invokes the generative AI model using this additional prompt sentence.

The server may repeat this optimization until the response satisfies predetermined criteria, thereby implementing a non-conventional loop between prompt generation and response evaluation that reduces the need for human manual review and improves response precision and consistency in a technical manner.

The server records the prompt sentences, the generated responses, the emotional state, the interest state, and the evaluation results as dialogue history information in the storage device.

The server assigns conversation identifiers and stores each dialogue transaction as a record with fields including input text, prompt sentence content, model configuration parameters, output text, emotion and interest labels, and evaluation scores.

The server aggregates this data periodically by computing statistics such as error rates per intent category or per emotion category.

The server uses the learning data update module to adjust generation rules for prompt sentences and to update learning data for the generative AI model and auxiliary models.

The server identifies intent categories or emotion categories with frequent misjudgments by analyzing evaluation results and user feedback data.

The server modifies the prompt templates for these categories, for example by adding more explicit constraints or additional examples, and stores the updated templates in the memory.

The server constructs updated training data sets that include difficult cases and corrected responses, and uses these data sets to fine-tune classifier models or smaller generative models used for classification or re-ranking.

The server may generate instruction-style text data pairs representing improved prompts and desired outputs and provide these pairs to an external training system for retraining the generative AI model.

By structuring and reusing prompt sentences and evaluation results in this manner, the server improves the internal behavior of the computer-implemented models, reducing error rates and unnecessary API calls.

The terminal presents interactive response programs built on top of the above mechanism. The terminal allows the user to switch between a configuration mode, where dialogue pattern information and custom responses are edited, and a conversation mode, where the user exchanges messages with an interactive response program.

The terminal sends, for example, a configuration request to the server when the user defines a new custom response, and receives updated system behavior automatically, without requiring manual programming.

The server publishes interactive response programs to other users by associating them with endpoints or identifiers and by managing access control.

The server logs operation histories of multiple users interacting with each published interactive response program.

The server aggregates these logs and uses the analytics module to compute usage tendencies and interest tendencies, such as frequently requested topics or typical emotional trajectories during sessions.

The server feeds these aggregated statistics into the prompt generation module and learning data update module to bias prompts and training data toward frequently observed usage patterns, thereby improving cache locality, reducing redundant computations, and improving throughput at the server.

The system achieves technical effects that go beyond mere automation of human reasoning.

The server uses explicit data structures, such as unified context objects and structured dialogue history records, to feed context, emotion, and usage statistics into prompt sentences in a programmatic manner, which reduces variation and increases the determinism of model behavior compared to ad-hoc manual prompting.

The server applies machine learning models in a coordinated pipeline to compress multi-modal signals into compact feature vectors, which reduces the size of data that must be transmitted to and from the generative AI model and which decreases communication load and processing time.

The server uses a feedback-driven loop that automatically adjusts prompt templates and learning data based on statistical evaluation of responses, which improves accuracy and reduces the need for repeated manual correction.

The server uses response evaluation and content verification before returning an answer, which reduces the number of erroneous outputs stored in logs and reused in later training, thereby lowering long-term model degradation.

The described architecture improves computer technology itself by optimizing internal data flows and computation patterns.

The server reduces the average number of calls to the generative AI model per user request by inserting domain-specific examples and constraints directly into the prompt sentence, thereby reducing the amount of trial-and-error interaction with the model and improving throughput.

The server improves cache efficiency and memory usage by storing and reusing prompt templates and by referencing dialogue history entries via identifiers instead of embedding full histories in every call.

The server improves latency by performing pre-classification and context fusion locally, so that the generative AI model receives only the most relevant pieces of context in an optimized format, which reduces the complexity of each model invocation and accelerates response generation.

In another embodiment, the server uses different neural network architectures for emotion and intent classification, such as a gated recurrent unit network for short text and a convolutional network for longer sequences, while maintaining the same prompt generation mechanism. In another embodiment, the server does not rely on external content metadata storage and instead builds embeddings of content descriptions using a separate encoder model; the server then incorporates nearest-neighbor results into the prompt sentence as metadata. In another embodiment, the server arranges the response evaluation and optimization module as a separate microservice that operates asynchronously, returning improved prompts to the main dialog engine for subsequent turns, thereby offloading computation and balancing system load.

The terminal may be implemented as a mobile terminal, a desktop terminal, or an embedded terminal connected to sensors in a physical environment.

The terminal may use local accelerators for pre-processing, such as specialized processors for encryption or signal processing, but the basic flow of transmitting user inputs, receiving prompt-driven responses, and presenting these responses remains consistent.

The system can thus be adapted to various hardware platforms while preserving the core mechanism of dynamic prompt sentence construction and feedback-based optimization of interactions with a generative AI model.

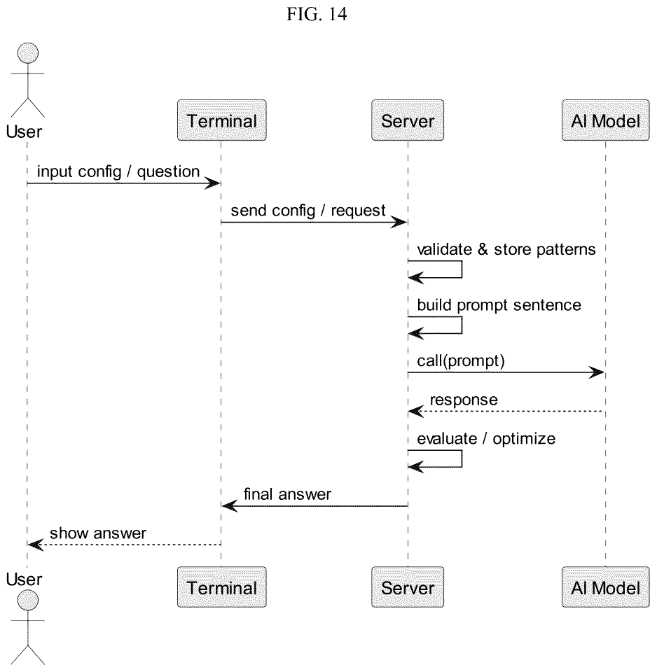

The following describes the processing flow using FIG. 14.

### Step 1

The user operates the terminal to input configuration data and dialog content. The user defines one or more question-answer pairs, selects an intent category, and optionally specifies constraints or tone preferences.

The terminal receives these inputs through text fields, selection lists, and buttons.
Input: raw keystrokes, touch events, and selection states from the user interface.

The terminal converts these raw events into structured configuration data, for example a record containing a question string, an answer string, an intent label, and user identifiers.
Output: structured configuration data ready to be transmitted to the server.

### Step 2

The terminal transmits the configuration data to the server.

The terminal packages the question-answer pairs and associated metadata into a structured message, such as a JSON or similar object.
Input: structured configuration data from Step 1.

The terminal performs serialization, attaches session identifiers and timestamps, and sends the serialized message via a network protocol to an API endpoint on the server.
Output: a network request containing configuration data delivered to the server.

### Step 3

The server receives and validates the configuration data.

The server parses the incoming message, checks required fields, and validates lengths and character encodings.
Input: serialized configuration message from the terminal.

The server converts the serialized message into internal objects, performs sanity checks (such as ensuring that question and answer are not empty), and rejects or corrects malformed data.
Output: validated configuration objects or error notifications.

### Step 4

The server stores the validated configuration as dialogue pattern information.

The server maps each question-answer pair to a dialogue pattern record in persistent storage and creates indices for efficient retrieval.
Input: validated configuration objects from Step 3.

The server writes these objects into data structures such as tables or collections, assigns pattern identifiers, and updates indices based on intent, keywords, and user identifiers.
Output: stored dialogue pattern records and updated index structures.

### Step 5

The user initiates a dialog session on the terminal.

The user switches the terminal into conversation mode and inputs a natural language request, such as a question or statement.
Input: user text input or speech input captured by the terminal.

The terminal converts speech to text if necessary, associates the text with the current session, and prepares a message representing the user request.
Output: a normalized user request (text and session metadata) ready to be sent to the server.

### Step 6

The terminal transmits the user request and any available context to the server.

The terminal includes information such as the current dialog session identifier, active content identifier, and recent interaction history references.
Input: normalized user request and session context from Step 5.

The terminal serializes these data and sends them through the communication interface to the server.
Output: a network request containing the user request and context delivered to the server.

### Step 7

The server aggregates multi-modal data and updates the dialog context.

The server collects text input, recent audio transcripts, image-based signals, and behavior logs associated with the current session.
Input: user request and session identifiers from Step 6 plus any previously stored session information.

The server merges these inputs into a unified context object in memory, linking the latest user request with prior turns and metadata such as intent guesses and emotion tags.
Output: an updated context object representing the full state of the dialog session.

### Step 8

The server estimates the user's emotional state and interest state.

The server applies one or more machine learning models to the aggregated multi-modal data.
Input: text, audio transcript, image features, and behavior features extracted within the context object from Step 7.

The server performs feature extraction (such as tokenization of text, embedding computation, and statistical analysis of interaction patterns) and then feeds the features into classification models that output probability distributions over emotion categories and interest categories.
Output: an estimated emotional state, an estimated interest state, and associated confidence scores.

### Step 9

The server identifies or confirms the user's intent.

The server uses an intent classification model and the stored dialogue pattern information to infer which type of request the user has issued.
Input: current user request text and dialogue history from the context object in Step 7.

The server tokenizes the text, encodes it into feature vectors, compares it to learned patterns, and selects one or more intent categories with associated scores.
Output: an intent classification result attached to the context object.

### Step 10

The server retrieves relevant dialogue pattern information.

The server queries the storage for dialogue patterns linked to the identified intent and possibly to the active domain or user.
Input: intent classification result from Step 9 and user or domain identifiers stored in the context.

The server searches indexed structures, filters patterns by relevance (for example, by keyword overlap or similarity metrics), and selects a subset of question-answer examples to use as guidance.
Output: a set of relevant dialogue pattern records, each containing a question, an answer, and metadata.

### Step 11

The server obtains content metadata when the user is consuming audiovisual content.

The server uses content identification information supplied in the context, such as content IDs or titles, to obtain detailed metadata.
Input: content identifiers and playback position from the context object in Step 7.

The server issues a query to a content metadata store, retrieves information like creator, year, and cast, and attaches this metadata to the context object as structured fields.
Output: an enriched context object including content metadata.

### Step 12

The server constructs a prompt sentence for the generative AI model.

The server selects a prompt template corresponding to the identified intent and integrates multi-modal signals and dialogue patterns.
Input: enriched context object from Steps 7-11 and retrieved dialogue pattern records from Step 10.

The server fills template placeholders with user request text, selected question-answer examples, emotional state, interest state, and content metadata, and formats these elements into a coherent natural language instruction.
Output: a concrete prompt sentence that specifies instructions to the generative AI model.

### Step 13

The server transmits the prompt sentence to the generative AI model.

The server uses a generative AI interface to send the prompt and control parameters such as maximum length and temperature.
Input: prompt sentence from Step 12 and model configuration parameters.

The server converts the prompt into the required request format, invokes the model through an application programming interface, and waits for a response.
Output: a model invocation request delivered to the generative AI model and a pending state within the server.

### Step 14

The server receives a candidate response from the generative AI model.

The generative AI model processes the prompt sentence and returns an output sequence representing a proposed answer.
Input: model response tokens or text returned via the application programming interface.

The server decodes the token sequence into text, associates the response with the corresponding prompt and session, and stores this raw response for further evaluation.
Output: a candidate response text linked to the prompt sentence and context.

### Step 15

The server evaluates the candidate response against rules and external information.

The server applies a language analysis model and rule sets to determine the quality and compliance of the response.
Input: candidate response text from Step 14, dialogue rules, operational rules, and optionally external data.

The server parses the response to identify key entities and claims, compares them with stored policies and external reference data, and computes evaluation metrics such as correctness, consistency, and tone alignment.
Output: an evaluation result including scores, flags, and recommended adjustments.

### Step 16

The server determines whether optimization or regeneration is required.

The server uses the evaluation result to decide whether the candidate response should be accepted or modified.
Input: evaluation result from Step 15.

The server checks thresholds and rule conditions; if any score falls below the threshold or any violation is detected, the server marks the response as insufficient.
Output: a decision value indicating acceptance or the need for correction or regeneration.

### Step 17

The server optionally generates an additional prompt sentence for correction.

When the response is insufficient, the server formulates a new instruction referencing the previous output and specifying constraints.
Input: candidate response text, evaluation result, and original prompt sentence from Steps 12-15.

The server constructs a corrective prompt, for example: “The previous answer mentioned a return period longer than allowed. Rewrite the answer so that the return period is within 30 days and remains consistent with the example policy,” and prepares this as a new prompt sentence.
Output: an additional prompt sentence designed to guide the generative AI model toward a corrected output.

### Step 18

The server re-invokes the generative AI model when correction is needed.

The server sends the additional prompt sentence to the generative AI model to obtain an improved response.
Input: additional prompt sentence from Step 17 and model parameters.

The server repeats the model call procedure, receives a revised answer, and optionally re-evaluates it using the same evaluation pipeline.
Output: a finalized response text that satisfies evaluation criteria.

### Step 19

The server records dialogue history information and learning data signals.

The server stores the prompt sentences, candidate responses, final responses, emotion and interest states, and evaluation metrics as structured records.
Input: final response text from Step 14 or 18, context object, and evaluation results.

The server writes these items into persistent storage, linking them by session identifiers and pattern identifiers, and computes aggregate statistics that serve as learning signals for future updates.
Output: updated dialogue history records and analytics data.

### Step 20

The server updates prompt generation rules and learning data based on accumulated records.

The server periodically analyzes stored history and feedback to refine model behavior.
Input: collected dialogue history records, user feedback, and error statistics from Step 19.

The server identifies patterns of frequent misjudgment, modifies template structures or example sets for specific intent or emotion categories, and prepares augmented data sets for training auxiliary models or adjusting model parameters.
Output: updated prompt templates, enhanced training data sets, and adjusted configuration parameters stored in the server.

### Step 21

The server sends the finalized response to the terminal.

The server packages the final answer text and optional explanation or metadata into a response message.
Input: finalized response text and associated context identifiers from Step 18 or 14.

The server serializes the response, attaches display hints or formatting instructions if necessary, and transmits the message through the network interface to the terminal.
Output: a network response carrying the final answer to the terminal.

### Step 22

The terminal presents the response to the user.

The terminal displays the received text in a chat interface or overlay and may also convert the text to speech.
Input: response message from the server in Step 21.

The terminal decodes the message, renders the text in the user interface, optionally invokes a speech synthesis component to produce audio, and updates any local session indicators such as the active intent or emotion state displays.
Output: a visual and/or auditory presentation of the system's response to the user.

### Step 23

The user optionally provides feedback on the response.

The user indicates satisfaction or dissatisfaction by selecting rating controls or by editing the response content.
Input: displayed answer and on-screen feedback controls on the terminal.

The terminal converts user actions into explicit feedback values or corrected text and sends these to the server for incorporation into learning data.
Output: user feedback data and optional corrected responses transmitted to the server.

### Step 24

The server integrates user feedback into the optimization cycle.

The server uses feedback to further refine dialogue patterns and evaluation thresholds.
Input: feedback data and corrected content from Step 23.

The server updates usage statistics and pattern records, flags problematic prompts or responses for template revision, and may generate new training instances that pair original prompts with corrected answers, thereby closing the loop between user interaction and internal model improvement.
Output: refined pattern data, adjusted rules, and enriched training resources stored for subsequent processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

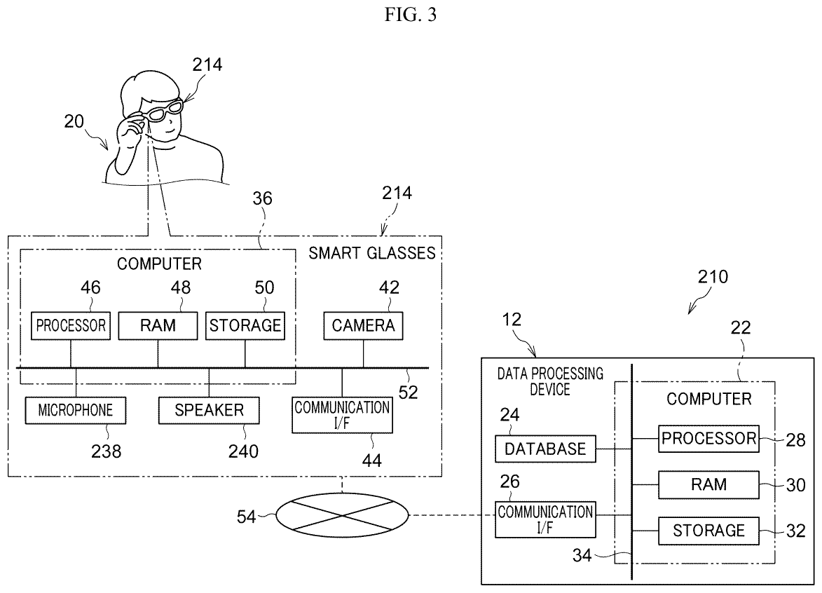

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

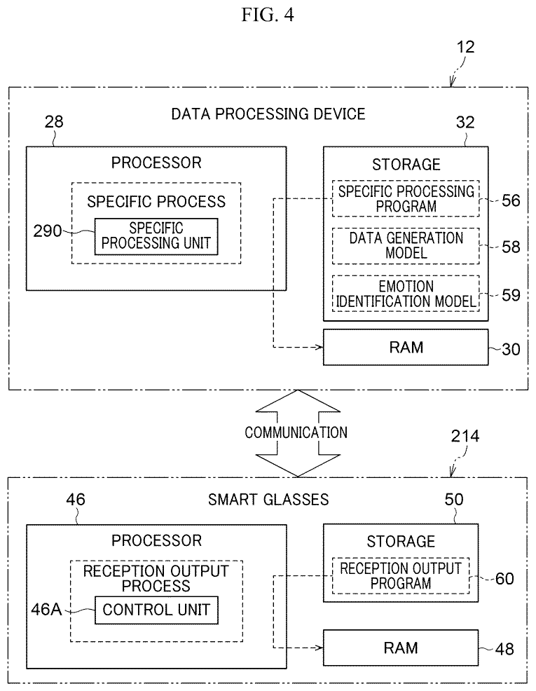

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

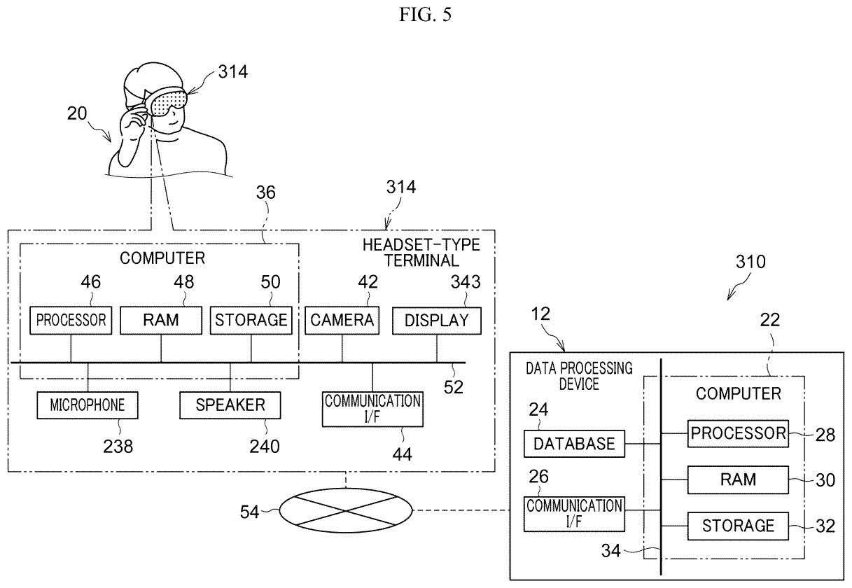

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

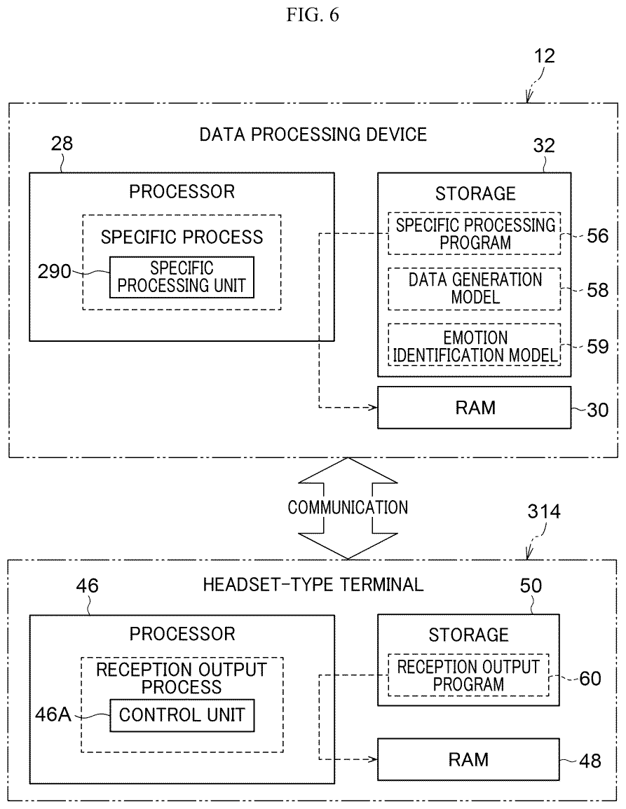

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

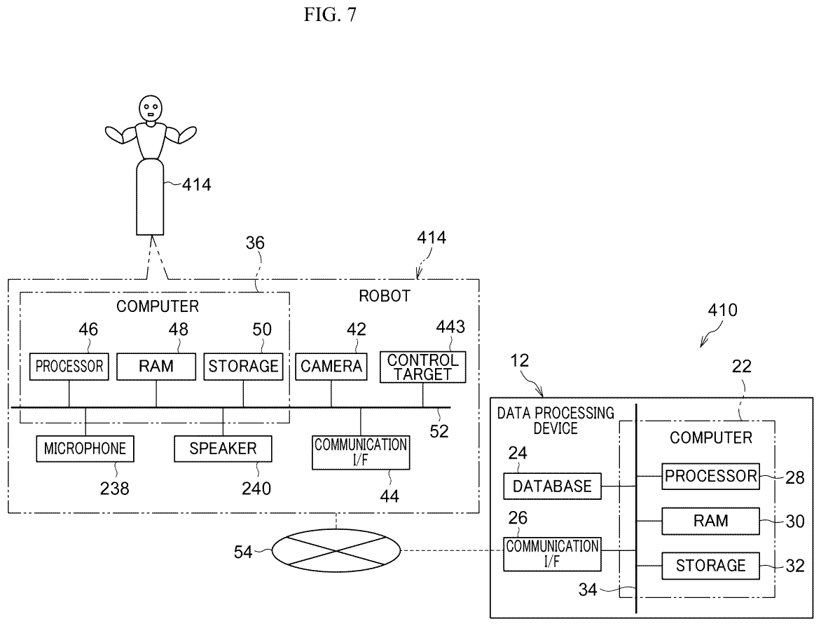

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46.

The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

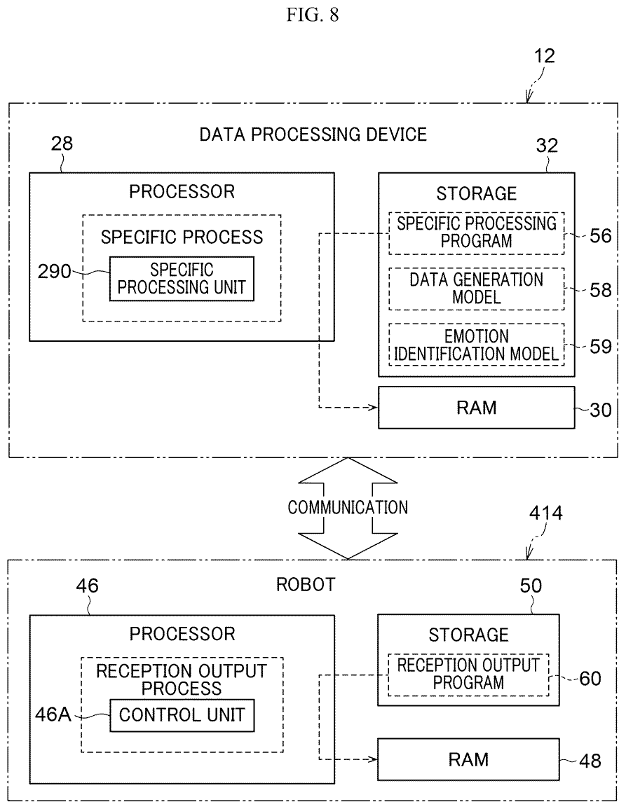

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

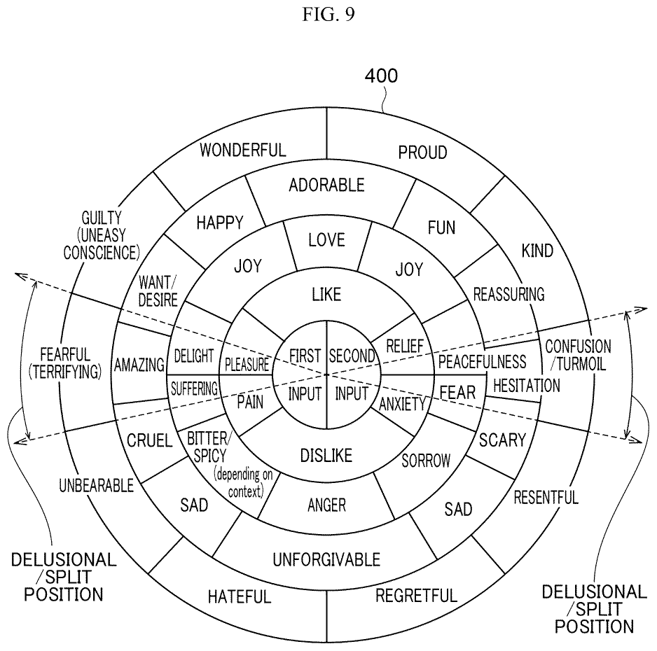

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

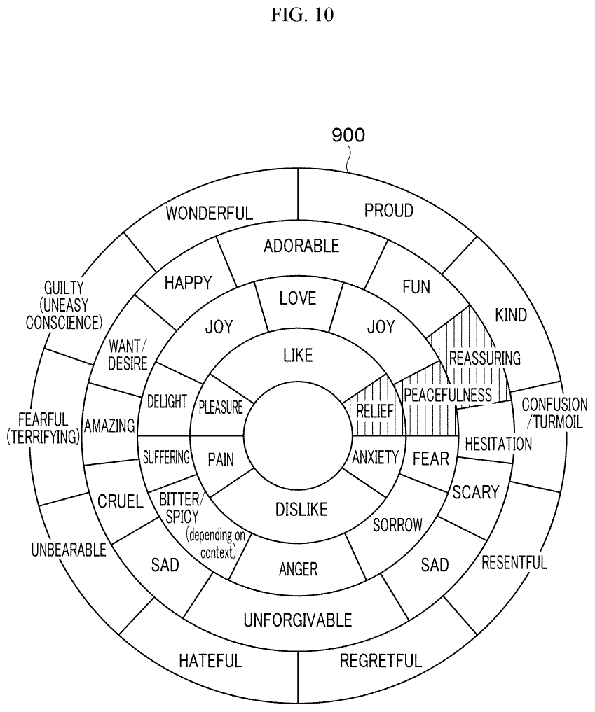

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via an application installed on an information processing apparatus or via a network-based interface, an operation from a user for making a generative AI model available,
acquire authentication information from the user, transmit the authentication information via a network, and establish an access right of the user based on the authentication information, acquire, from a storage of a terminal or from an external storage service, a training data set selected by the user for updating learning data of the generative AI model, and transmit the training data set to a server via the network,
at the server, receive the training data set, verify integrity of the training data set, perform preprocessing including format conversion, normalization, tokenization, and data splitting on the training data set, and convert the training data set into training data in a format suitable for learning of the generative AI model,
at the server, execute retraining or fine-tuning of the generative AI model by using the preprocessed training data as input and by using a machine learning program executed on a numerical computation device, generate an updated generative AI model, and store the updated generative AI model in a storage,
acquire, in accordance with setting operations in the application, configuration information including a purpose, a response policy, constraint conditions, and example dialogs of a dialog-type program that uses the updated generative AI model, from the user, and transmit the configuration information to the server,
at the server, construct the dialog-type program based on the configuration information, the dialog-type program including system-level instruction text, templates, and state management information, and register the dialog-type program in association with the updated generative AI model,
acquire from the user an input including a prompt sentence for dialog, and transmit information including the input and a dialog history, together with an identifier that identifies the dialog-type program, to the server,
at the server, construct, based on the identifier, the configuration information associated with the identifier, and the dialog history, a prompt sentence for instructing the generative AI model to generate a response, convert the prompt sentence into a token sequence, input the token sequence to the generative AI model, generate a response candidate by inference processing of the generative AI model, and determine a natural language response by decoding and post-processing,
at the server, sequentially input a test input data set to the dialog-type program, evaluate responses obtained from the generative AI model via the dialog-type program by language analysis processing, generate control information for updating the training data set based on an evaluation result, and update learning data of the generative AI model using the control information to improve response quality of the dialog-type program,
analyze an operation history and a dialog history of the user, estimate an interest of the user, automatically generate, based on an estimation result, a prompt sentence for instructing the generative AI model to generate appropriate information, and adjust a response or information to be presented by using the prompt sentence, and
publish the dialog-type program such that the dialog-type program is usable from an external apparatus connected via a network or from a local environment, and provide, to an input from a user of the published dialog-type program, a response generated by the generative AI model via the server.

### Supplementary 2

The system according to supplementary 1,
wherein the processor is configured to
acquire at least one of text data, audio data, and image data input by the user, estimate an emotional state of the user from the data by using machine learning processing, construct, based on the estimated emotional state and the configuration information regarding the dialog-type program, a prompt sentence for instructing the generative AI model to generate a response adapted to the emotional state, and input the prompt sentence to the generative AI model at the server to adjust the response.

### Supplementary 3

The system according to supplementary 1,
wherein the processor is configured to
automatically transmit a plurality of predefined test input data to the dialog-type program, perform an evaluation process that analyzes responses of the generative AI model obtained via the dialog-type program based on quality indices, the constraint conditions, and a degree of conformity to the example dialogs, generate control information that defines update contents of the training data set and relearning conditions of the generative AI model based on a result of the evaluation process, and update learning data of the generative AI model and the configuration information of the dialog-type program by using the control information.

### Application Example 1

### Supplementary 1

A system comprising a processor,
wherein the processor is configured to
receive, via an application or an information presentation screen provided by an information processing terminal, input from a user including a request content, and receive an operation to make a generative AI model available on the basis of the input,
analyze input data including the request content acquired from the information processing terminal, construct a prompt sentence for causing the generative AI model to generate a response, transmit the prompt sentence to the generative AI model, and obtain response data generated by the generative AI model,
configure, on the basis of the response data obtained from the generative AI model, an automatic response function that provides responses in a dialog format, and publish the automatic response function via a communication path or a storage resource so that other users are able to use the automatic response function,
transmit a group of test input data to the automatic response function, analyze test response data generated by the automatic response function, generate control information for updating a training data set of the generative AI model on the basis of an analysis result, and improve response quality of the generative AI model by using the control information,
acquire at least one of user input text data, user acoustic data, or user image data, analyze the acquired data by using an identification information processing model to specify an emotional state of the user, construct a prompt sentence for causing the generative AI model to generate a response adapted to the emotional state, and optimize the response on the basis of the prompt sentence,
receive, on the basis of a dialog history, an individual response setting for a specific inquiry, and construct a prompt sentence for causing the generative AI model to generate a response having a specific content in accordance with a control condition including the individual response setting,
collect operation history data of a plurality of users using the automatic response function, analyze the operation history data to specify interest information of each user or a user group, construct a prompt sentence for causing the generative AI model to generate provision information on the basis of the specified interest information, and present the provision information via the information processing terminal,
identify viewing target content being viewed by the user, and construct a prompt sentence for instructing the generative AI model to extract or generate related information so as to acquire additional information related to the viewing target content,
acquire user evaluation data transmitted from the information processing terminal, store the user evaluation data in association with the request content, the prompt sentence, and the response data of the generative AI model, execute a learning control process for updating at least one of the training data set of the generative AI model or a rule for constructing the prompt sentence on the basis of an accumulated history of responses accompanied by evaluations, and improve relevance and usefulness of subsequent response generation processing by using an update result, and
control an external training information processing apparatus or an internal training processing function to execute an adjustment process or a fine-tuning process of the generative AI model on the basis of a training data set generated from the user evaluation data, the request content, and the response data, and reflect an adjusted generative AI model or the rule for constructing the prompt sentence, after the adjustment process, in the response generation processing.

### Supplementary 2

The system according to supplementary 1,
wherein the processor is configured to collect user evaluation data for a plurality of request contents and response data, aggregate and classify the user evaluation data, classify the response data into preferred examples and non-preferred examples on the basis of evaluation values, generate a training data set including a classification result, and generate control information for adjusting an output tendency of the generative AI model on the basis of the training data set.

### Supplementary 3

The system according to supplementary 1,
wherein the processor is configured to store, in time series, response history information in which the prompt sentence including the request content transmitted from the information processing terminal, the response data obtained from the generative AI model, and the user evaluation data are associated with one another, and dynamically change at least one of a construction method of the prompt sentence, a selection condition of the generative AI model, or a response presentation order on the basis of the response history information, thereby performing information provision processing adapted to interest information of each user.

### Example 2

### Supplementary 1

A system comprising a processor,
wherein the processor is configured to
receive, via a user input/output interface operating on a terminal device, an operation for configuring dialog processing using a generative AI model,
analyze a request input from the terminal device by a user and create a prompt sentence for causing the generative AI model to generate a response,
transmit the prompt sentence to the generative AI model and obtain a response generated by the generative AI model,
configure a chatbot function that provides an interactive response based on the response obtained from the generative AI model,
transmit test input data to the chatbot function and analyze a response generated by the chatbot function in order to evaluate appropriateness of the response of the chatbot function,
update a learning data set of the generative AI model by using an evaluation result obtained by the analysis, and improve response quality of the chatbot function,
acquire at least one of user input text data, audio data, and image data, and analyze the acquired data to identify an emotional state of the user,
create, based on the identified emotional state, a prompt sentence for causing the generative AI model to generate a response suitable for the emotional state, and optimize the response by using the prompt sentence,
receive, via an information terminal, an input of a response pattern including a specific inquiry and response content corresponding to the inquiry from the user, and register the response pattern as a custom response,
generate, based on a combination of the inquiry and the response content included in the registered response pattern, a prompt sentence explicitly indicating to the generative AI model that “when the user makes a predetermined inquiry, respond with predetermined response content,” and transmit the prompt sentence to the generative AI model to cause the generative AI model to learn the custom response,
search, when a dialog inquiry is input from the user after the custom response has been registered, a data storage device for a response pattern corresponding to the inquiry,
dynamically construct a prompt sentence to be given to the generative AI model in accordance with a search result, and control the generative AI model so as to generate a specific response that reflects an intention of the user,
publish the chatbot function in an online environment via a communication network or in a stand-alone local environment so that other users can use the chatbot function,
analyze operation history information of a plurality of users who use the chatbot function,
identify interest information for each user, and create a prompt sentence for instructing the generative AI model to generate information to be provided based on the identified interest information,
identify content data that the user is currently viewing or watching, and create a prompt sentence for instructing the generative AI model to acquire and generate information related to the identified content data,
obtain a plurality of pairs of inquiries and response contents used for registration of the custom response, automatically generate a prompt sentence for causing the generative AI model to learn each of the pairs, and supply the prompt sentences to the generative AI model collectively so as to cause the generative AI model to efficiently learn a plurality of response patterns set by the user, and
perform similarity calculation based on semantic representations of inquiry sentences for a plurality of response patterns registered as the custom response, identify a response pattern closest to a new inquiry from the user, and cause the generative AI model to generate an appropriate response by including a prompt sentence corresponding to the identified response pattern in input to the generative AI model.

### Supplementary 2

The system according to supplementary 1,
wherein the processor is configured to
obtain a pair of an inquiry and response content input by the user, normalize an expression of the inquiry into a unified character string format, generate a template-based prompt sentence in which the response content is embedded as an instruction sentence to the generative AI model, and control operation of the generative AI model based on user-defined response patterns by combining a plurality of the template-based prompt sentences to constitute an instruction information set for the generative AI model.

### Supplementary 3

The system according to supplementary 1,
wherein the processor is configured to
perform vectorization processing to generate feature quantities of the inquiry for each response pattern registered by the user, provide a search processing unit that executes similarity search by using the generated feature quantities, cause the search processing unit to extract, with respect to an inquiry input during dialog, a response pattern having highest similarity, and determine a prompt sentence to be given to the generative AI model based on the extracted response pattern so as to preferentially reflect the custom response on the inquiry during dialog.

### Application Example 2

### Supplementary 1

A system comprising a processor,
wherein the processor is configured to
receive, via an application or a web interface operating on an information processing apparatus, an operation for using a generative AI model and a request input from a user, and
analyze the request to determine an intent and a context and generate a prompt sentence that specifies an instruction to the generative AI model,
embed, into the generated prompt sentence, dialogue pattern information including a correspondence between a user-defined question and a user-defined answer and dialogue history information, and construct the prompt sentence so as to cause the generative AI model to generate a specific response based on the dialogue pattern information,
acquire at least part of text data, audio data, image data, and behavior log data from the information processing apparatus, and analyze the acquired data by using a machine learning model to estimate an emotional state and an interest state of the user,
add the estimated emotional state and the interest state to the prompt sentence in combination with the user request and the dialogue history, and generate a prompt sentence that causes the generative AI model to generate a response adapted to the emotional state and the interest state,
identify a content being viewed or listened to by acquiring content identification information relating to audiovisual content, obtain related metadata based on the content identification information, and generate a prompt sentence including the related metadata to instruct the generative AI model to generate explanatory information relating to the content,
evaluate appropriateness and consistency of a response obtained from the generative AI model based on dialogue rules, operational rules, and external information sources, and, when necessary, generate an additional prompt sentence to instruct the generative AI model to correct or regenerate the response so as to optimize the response,
record, as dialogue history information, the response output by the generative AI model, the prompt sentence used to generate the response, the emotional state of the user, the interest state of the user, and an evaluation result of the response, and update generation rules for the prompt sentence and learning data for the generative AI model based on the recorded dialogue history information and feedback information from the user so as to continuously improve performance of subsequent response generation,
publish, in an online environment or a local environment, an interactive response program created based on instructions to the generative AI model so that other users can use the interactive response program, analyze operation histories of a plurality of users who use the published interactive response program to extract a usage tendency and an interest tendency, and automatically adjust the prompt sentence and the learning data based on an extraction result, and
present, via the application or the web interface operating on the information processing apparatus, the dialogue pattern information, the custom response, and response content adapted to the emotional state and the interest state to the user, receive correction input from the user, and update the dialogue pattern information and the learning data based on the correction input.

### Supplementary 2

The system according to supplementary 1,
wherein the processor is configured to acquire at least one of the text data, the audio data, the image data, and the behavior log data of the user, input the acquired data to the machine learning model so as to classify an emotion category and an interest category, generate feature information representing a classification result, and add the feature information to the prompt sentence so as to cause the generative AI model to adjust the response based on the feature information.

### Supplementary 3

The system according to supplementary 1,
wherein the processor is configured to transmit a plurality of test input data items in batch to the interactive response program, automatically evaluate responses obtained from the interactive response program by using a language analysis model and evaluation rules, and
generate a prompt sentence that instructs selective modification of a template of the prompt sentence and the learning data corresponding to an intent category or an emotion category in which misjudgment frequently occurs, based on an evaluation result.

What is claimed is:

1. A system comprising:
circuitry configured to:
receive, via a packet-switched network, input data including a character string representing a request;
construct a structured prompt based on the input data, the structured prompt including a system instruction portion and the character string;
transmit the structured prompt to a generative neural network model comprising a transformer-based architecture;
acquire, from the generative neural network model, response data generated based on the structured prompt;
configure, based on the response data, a dialog-type processing program that provides automatic responses; and
store interaction records associating the structured prompt and the response data in a storage device.

2. The system according to claim 1, wherein the circuitry is further configured to:
convert the character string into a token sequence using a tokenizer compatible with the generative neural network model, the token sequence including subword token identifiers and positional encodings; and
apply a decoding algorithm to output logits produced by the generative neural network model to generate a sequence of output token identifiers constituting the response data.

3. The system according to claim 2, wherein the circuitry is further configured to:
apply post-processing to the response data including removal of incomplete terminal sequences, normalization of spacing and punctuation, and filtering of terms according to constraint conditions stored in a configuration repository.

4. The system according to claim 3, wherein the circuitry is further configured to:
acquire multimodal sensor data from a terminal device, the multimodal sensor data including at least one of character string input data, audio signal data, and image capture data;
process the multimodal sensor data using an identification information processing model to compute a probability distribution over a plurality of affective state categories; and
encode a detected affective state as a symbolic tag and append the symbolic tag to the structured prompt to condition the response data on the detected affective state.

5. The system according to claim 4, wherein the identification information processing model comprises at least one of a convolutional neural network for processing the image capture data and a recurrent neural network for processing the audio signal data, and the circuitry is further configured to:
preprocess the audio signal data by converting the audio signal data into a mel-spectrogram representation; and
normalize the image capture data prior to feature extraction.

6. The system according to claim 5, wherein the circuitry is further configured to:
receive training data including pairs of prompt sentences and target response sentences;
preprocess the training data by applying text normalization, tokenization using the tokenizer, and partitioning into a training subset and a validation subset; and
execute fine-tuning of the generative neural network model by computing forward passes through transformer blocks, calculating a loss value using a cross-entropy function, computing gradients via backpropagation, and updating weight parameters using an optimizer.

7. The system according to claim 6, wherein the circuitry is further configured to:
transmit a plurality of predefined test input sentences to the dialog-type processing program;
collect generated responses from the dialog-type processing program for each test input sentence;
evaluate the generated responses using a language analysis algorithm to compute evaluation scores; and
generate control information based on the evaluation scores for updating the training data or training configuration parameters.

8. The system according to claim 7, wherein the circuitry is further configured to:
accumulate operation history data representing interactions of a user with the dialog-type processing program, the operation history data including at least prompt sentences, response selections, and temporal information;
analyze the operation history data to compute inferred preference data of the user; and
modify a prompt construction rule based on the inferred preference data to adjust contents of subsequently constructed structured prompts.

9. The system according to claim 8, wherein the circuitry is further configured to:
receive, from the terminal device, viewing target content data identifying content currently being accessed by the user;
retrieve metadata associated with the viewing target content data; and
insert the metadata into the structured prompt as a contextual block to condition the response data on the viewing target content data.

10. The system according to claim 9, wherein the circuitry is further configured to:
enable the user to define a custom response mapping associating a specific inquiry pattern with a designated response based on a dialog history; and
construct, when the specific inquiry pattern is detected in a subsequent input, a structured prompt that includes the designated response as an instruction to the generative neural network model.

11. The system according to claim 10, wherein the circuitry is further configured to:
register the dialog-type processing program in a storage resource accessible via the packet-switched network so that a second user is able to interact with the dialog-type processing program from a second terminal device.

12. The system according to claim 11, wherein the circuitry is further configured to:
maintain a plurality of generative neural network models including a general-purpose model and a domain-specific model; and
select, based on at least one of keyword detection, topic embedding computation, and user profile data, which of the plurality of generative neural network models to apply for generating the response data.

13. The system according to claim 12, wherein the circuitry is further configured to:
generate a plurality of candidate structured prompts for a single input, each candidate structured prompt differing by at least one of the system instruction portion, an affective state tag, or a contextual block;
compute a ranking score for each candidate structured prompt based on historical performance data; and
select the candidate structured prompt having the highest ranking score for transmission to the generative neural network model.

14. The system according to claim 13, wherein the circuitry is further configured to:
receive evaluation feedback data from the terminal device including at least one of a rating value, a selection event, and a correction input associated with the response data; and
store the evaluation feedback data in the storage device in association with the corresponding structured prompt and response data as a linked record.

15. The system according to claim 14, wherein the circuitry is further configured to:
perform time-series analysis on the linked records to detect trends in evaluation feedback data; and
adjust at least one of a model selection condition, a prompt construction rule, and a training configuration parameter based on the detected trends.

16. The system according to claim 15, wherein the circuitry is further configured to:
construct an extended prompt by concatenating the system instruction portion, formatted past dialog turns with role markers, an affective state tag derived from the multimodal sensor data, contextual metadata derived from the viewing target content data, and the character string representing the current request.

17. The system according to claim 16, wherein the decoding algorithm comprises at least one of greedy decoding, top-k sampling, and nucleus sampling, and the circuitry is further configured to:
set a temperature parameter for the generative neural network model to control randomness of the response data; and
apply token masking during decoding to prevent generation of predetermined prohibited token sequences.

18. A system comprising:
circuitry configured to:
receive, via a packet-switched network, input data including a character string representing a request from a terminal device;
acquire multimodal sensor data from the terminal device including at least one of character string input data, audio signal data, and image capture data;
process the multimodal sensor data using an identification information processing model to determine an affective state classification;
construct a structured prompt based on the character string, a system instruction portion, and a symbolic tag encoding the affective state classification;
transmit the structured prompt to a generative neural network model comprising a transformer-based architecture and acquire response data;
configure, based on the response data, a dialog-type processing program;
transmit predefined test input sentences to the dialog-type processing program, evaluate generated responses using a language analysis algorithm, and generate control information for updating training data of the generative neural network model; and
store interaction records and evaluation feedback data in a storage device as linked records for time-series analysis.

19. The system according to claim 18, wherein the circuitry is further configured to:
accumulate operation history data of a user interacting with the dialog-type processing program;
compute inferred preference data from the operation history data; and
modify a prompt construction rule based on the inferred preference data and register the dialog-type processing program in a storage resource accessible via the packet-switched network for use by a second user.

20. A method performed by circuitry, the method comprising:
receiving, via a packet-switched network, input data including a character string representing a request;
constructing a structured prompt based on the input data, the structured prompt including a system instruction portion and the character string;
transmitting the structured prompt to a generative neural network model comprising a transformer-based architecture;
acquiring, from the generative neural network model, response data generated based on the structured prompt;
configuring, based on the response data, a dialog-type processing program that provides automatic responses; and
storing interaction records associating the structured prompt and the response data in a storage device.
